(19) United States
(12) Patent Application Publication
(10) Pub. No.: US 2026/0256133 A1
(43) Pub. Date: Sep. 3, 2026

(54) AN EMULSIFIABLE CONCENTRATE HAVING A (SUBSTITUTED) BENZALDEHYDE-BASED SOLVENT SYSTEM

(71) Applicant: BASF SE, Ludwigshafen Am Rhein (DE)

(72) Inventors: Adam BLANAZS, Ludwigshafen (DE); Peter HOFER, Ludwigshafen (DE); Ingo FLEUTE-SCHLACHTER, Ludwigshafen (DE)

(21) Appl. No.: 18/846,945

(22) PCT Filed: Feb. 23, 2023
(86) PCT No.: PCT/EP23/54565

§ 371 Date: Sep. 13, 2024

(30) Foreign Application Priority Data
Apr. 25, 2022 (EP) 22169757.6

(51) Int. Cl. A01N 25/04; A01N 43/54; A01N 43/653

(52) U.S. Cl. CPC A01N 25/04; A01N 43/54; A01N 43/653

(57) ABSTRACT

Disclosed herein is an emulsifiable concentrate (EC) including one or more pesticides, one or more emulsifiers and certain benzaldehyde-derived solvents, an emulsion-in-water (EW) formulation formed from the emulsifiable concentrate (EC), and a method of using certain benzaldehyde-derived solvents as a solvent in an agrochemical emulsifiable concentrate.

### FIELD OF THE INVENTION

The present invention is directed to an emulsifiable concentrate (EC) comprising one or more pesticides, one or more emulsifiers and certain benzaldehyde-derived solvents, to an emulsion-in-water (EW) formulation formed from said emulsifiable concentrate (EC), and to the use of the certain benzaldehyde-derived solvents as a solvent in an agrochemical emulsifiable concentrate.

### BACKGROUND TO THE INVENTION

When preparing agrochemical formulations, it is usually required to dissolve the agrochemically active ingredient, e.g. one or more pesticides in a solvent, which is then diluted in a larger volume of water in order for it to be applied in the form of a fine spray. Alternatively, it may be necessary to dilute the agrochemically active ingredient in a solution and load it onto a seed or solid carrier. Whilst some agrochemically active ingredients are salts and thus highly water-soluble, allowing for simply dissolution, many other non-ionic agrochemically active ingredients are hydrophobic and not at all water-soluble.

In the case of active ingredients that are not water-soluble, it is normally necessary to dissolve the formulation in a water-immiscible solvent and add one or more surfactants, so that the solution will form an oil-in-water emulsion, when added to water. Such a formulation is called an Emulsifiable Concentrate (EC) formulation. Alternatively, the water-immiscible solution comprising active ingredient can be pre-emulsified in water in a concentrated form. Such a formulation is called an Emulsion-in-water (EW) formulation.

Water-immiscible solvents commonly used for EC and EW formulations include, but are not limited to, aromatic hydrocarbons such as the SOLVESSO® series, paraffinic hydrocarbons such as the EXXSOL® range, ester solvents such as the EXXATE® range, all of which are manufactured by EXXONMOBIL, and ester solvents such as methyloleate. Further, solvents which are water-immiscible at high concentration include cyclic hydrocarbons, such as cyclohexanone and isophorone. In more recent times, solvents which exhibit improved toxicity and reduced flammability profiles have been used. These include the dibasic ester solvents of long chain di-acids having from 8-16 carbon units, which are usually methyl ester derivatives, and fatty acid amide solvents, examples of which are the dimethylamide and morpholineamide derivatives of C₆-C₁₆ fatty acids. Mono-alkylene carbonates such as ethylene, propylene and butylene carbonates, also find use as co-solvents.

Combinations of water-immiscible solvents with highly polar water-miscible co-solvents such as N-methyl pyrrolidinone (NMP), dimethylsulphoxide, dimethylisosorbide, monoethylene glycol, monopropylene glycol and various glycol ethers have been used in the past to achieve physical stability of the EC formulation, particularly if crystallisation of the active ingredient occurs at below ambient temperature. However, the use of such solvent combinations often leads to the problem of crystallisation in the diluted formulation.

There exists in the pesticide industry a great desire to find alternatives to currently used solvents such as fatty acid esters, fatty acid amides, isophorone, methyl butyl ketone (MBK), NMP, etc. which may be expensive, difficult to source and/or are environmentally unattractive due to their inherent phytotoxicity, toxicity (e.g. teratogenicity) or regulatory status.

Solvents that avoid these phytotoxic/environmentally harmful properties are known, for example benzyl acetate; however, these solvents typically are only able to achieve moderate solubility across the broad range of commercially important pesticides. In particular, azoxystrobin and prothioconazole, both common fungicides, are known to be sparingly soluble in many of the solvents conventionally used.

As such, there remains a need for solvents suitable for use in emulsifiable concentrate formulations and emulsion-in-water formulations, which combine low phytotoxicity and generally benign (e.g. non-irritant) properties with high solubility for a range of commonly employed agrochemical active ingredients.

### SUMMARY OF THE INVENTION

The finding of the present invention is that certain benzaldehyde-derived solvents combine low phytotoxicity and generally benign (e.g. non-irritant) properties with high solubility for a range of commonly employed agrochemical active ingredients.

In a first aspect, the present invention is directed to an emulsifiable concentrate (EC) comprising one or more pesticides, one or more emulsifiers and one or more solvents, wherein at least one of the one or more solvents has a structure according to formula (I):

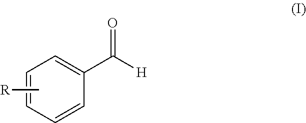

wherein R represents 0 to 5 substitutions, wherein each instance of R is selected from the group consisting of deuterium, halogen, C₁ to C₁₀ alkyl, aryl, OR¹, and NR¹₂, wherein each R¹ is selected from the group consisting of hydrogen and C₁ to C₁₀ alkyl, and optionally two instances of R can be joined to form a 5-membered or 6-membered ring.

In a further aspect, the present invention is directed to an emulsion-in-water (EW) formulation, comprising an aqueous phase and a non-aqueous phase, wherein the non-aqueous phase is the emulsifiable concentrate (EC) of the first aspect.

In another aspect, the present invention is directed to a use of a compound having a structure according to formula (I)

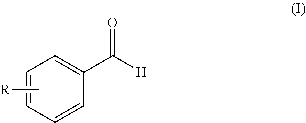

wherein R represents 0 to 5 substitutions, wherein each instance of R is selected from the group consisting of deuterium, halogen, C₁ to C₁₀ alkyl, aryl, OR¹, and NR %, wherein each R¹ is selected from the group consisting of hydrogen and C₁ to C₁₀ alkyl, and optionally two instances of R can be joined to form a 5-membered or 6-membered ring,
as a solvent in an agrochemical emulsifiable concentrate, preferably the emulsifiable concentrate (EC) according to the first aspect.

In a final aspect, the present invention is directed to a use of the emulsion-in-water (EW) formulation according to the further aspect described above for treating plants, thereby maintaining plant health, without causing plant damage.

### Definitions

Emulsifiable concentrates are typically optically transparent oily liquid formulations that are prepared by dissolving a certain amount of pesticide in organic solvents (such as benzene, toluene, xylene, and solvent oil), which may also contain surfactants (i.e. emulsifiers) and other additives. These concentrates are suitable for dispersion within an aqueous phase to form an emulsion-in-water formulation. Emulsifiable concentrates must be monophasic, i.e. the pesticide and any emulsifiers must be completely soluble in the organic solvent at the concentrations used.

An emulsion is a mixture of two or more liquids that are normally immiscible, wherein one liquid forms a dispersed phase, suspended as tiny droplets within the other liquid, which is known as the continuous phase. Emulsions are typically referred to as oil-in-water (i.e. the water is the continuous phase) or water-in-oil (i.e. the oil is the continuous phase). In the context of agrochemical formulations, oil-in-water emulsions, known as emulsion-in-water formulations are often used to disperse hydrophobic pesticides across fields of crop plants.

The U.S Environmental Protection Agency (EPA) defines a pesticide as “any substance or mixture of substances intended for preventing, destroying, repelling, or mitigating any pest”. A pesticide may be a chemical substance or biological agent (such as a virus or bacteria) used against pests including insects, plant pathogens, weeds, molluscs, birds, mammals, fish, nematodes (roundworms) and microbes that compete with humans for food, destroy property, spread disease or are a nuisance. In the context of agrochemical formulations, pesticides are used to actively target pests, typically fungi, insects, and/or weed plants, without unduly harming the crop plant.

Phytotoxicity describes any adverse effects on plant growth, physiology or metabolism caused by a chemical or biological substance. In the context of agrochemical formulations, it is desired to avoid phytotoxic properties in order that the health of the crop plant is not impacted.

In the context of the present invention, alkyl refers to linear and branched chains alkyl chains, whilst aryl refers to any aromatic carbocyclic ring system, being either a single ring, for example phenyl group or a fused ring system, for example a naphthyl group or an anthracenyl group.

### DETAILED DESCRIPTION

In a first aspect, the present invention is directed to an emulsifiable concentrate (EC) comprising one or more pesticides, one or more emulsifiers and one or more solvents, wherein at least one of the one or more solvents has a structure according to formula (I):

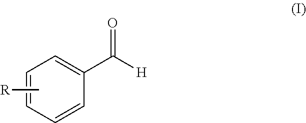

wherein R represents 0 to 5 substitutions, wherein each instance of R is selected from the group consisting of deuterium, halogen, C₁ to C₁₀ alkyl, aryl, OR¹, and NR¹₂, wherein each R¹ is selected from the group consisting of hydrogen and C₁ to C₁₀ alkyl, and optionally two instances of R can be joined to form a 5-membered or 6-membered ring.

### The Solvent

One essential component of the emulsifiable concentrate (EC) is one or more solvents.

At least one of the one or more solvents according to the present invention has a structure according to formula (I):

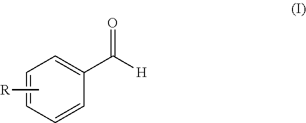

wherein R represents 0 to 5 substitutions, wherein each instance of R is selected from the group consisting of deuterium, halogen, C₁ to C₁₀ alkyl, aryl, OR¹, and NR¹₂, wherein each R¹ is selected from the group consisting of hydrogen and C₁ to C₁₀ alkyl, and optionally two instances of R can be joined to form a 5-membered or 6-membered ring.

In a preferred embodiment, the at least one of the one or more solvents according to the present invention has a structure according to formula (I):

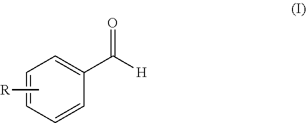

wherein R represents 0 to 5 substitutions, wherein each instance of R is selected from the group consisting of deuterium, halogen, C₁ to C₁₀ alkyl, aryl, OR¹, and NR¹₂, wherein each R¹ is selected from the group consisting of C₁ to C₁₀ alkyl, and optionally two instances of R can be joined to form a 5-membered or 6-membered ring.

R represents 0 to 5 substitutions, i.e. 0, 1, 2, 3, 4, or 5 substitutions; however, it is preferred that R represents 0, 1, or 2 substitutions, more preferably 1 or 2 substitutions, alternatively 0 or 1 substitutions, most preferably 1 substitution.

Each instance of R is selected from the group consisting of deuterium, halogen, C₁ to C₁₀ alkyl, aryl, OR¹, and NR¹₂, wherein each R¹ is selected from the group consisting of hydrogen and C₁ to C₁₀ alkyl, and optionally two instances of R can be joined to form a 5-membered or 6-membered ring.

The 5-membered or 6-membered ring formed from two instances of R may be a carbocyclic ring or a heterocyclic ring. Preferred examples of a carbocyclic ring include R═—(CH₂)₄— and R═—(CH₂)₃—, whilst preferred examples of a heterocyclic ring include R═—O(CH₂)₃—, R═—O(CH₂)₂O—, R═—O(CH₂)₂—, and R═—OCH₂O—. The carbocyclic or heterocyclic rings may also be aromatic, for example R═—(CH)₄—, R═—N(CH)₃—, R═—(CH)N(CH)₂—, R═—(NR¹)(CH)₂—, and R═—(CH)(NR¹)(CH)—.

Preferably, each instance of R is selected from the group consisting of C₁ to C₁₀ alkyl, aryl and OR¹, more preferably the group consisting of C₁ to C₁₀ alkyl and OR¹ wherein each R¹ is selected from the group consisting of hydrogen and C₁ to C₁₀ alkyl.

Each R¹ is selected from the group consisting of hydrogen and C₁ to C₁₀ alkyl, preferably from the group consisting of hydrogen and C₁ to C₄ alkyl, more preferably from H, Me and Et, most preferably R¹ is methyl.

In one embodiment, it is preferred that each instance of R is selected from the group consisting of C₁-C₄ alkyl and OR¹, wherein R¹ is selected from the group consisting of hydrogen and C₁ to C₄ alkyl. In said embodiment, it is preferred that R represents 0, 1 or 2 substitutions, more preferably 0 or 1 substitutions, most preferably 1 substitution.

In another embodiment, it is preferred that each instance of R is selected from the group consisting of HO, EtO, MeO, Et, and Me. In said embodiment it is preferred that that R represents 0, 1 or 2 substitutions, more preferably 0 or 1 substitutions, most preferably 1 substitution.

It is further preferred that each instance of R is OR¹, wherein each R¹ is selected from the group consisting of hydrogen and C₁ to C₁₀ alkyl, more preferably from the group consisting of hydrogen and C₁ to C₄ alkyl, yet more preferably from H, Me and Et, most preferably R¹ is methyl.

It is particularly preferred that R represents one substitution and that this substitution is OMe.

As such, it is preferred that the solvent is selected from the group consisting of 2-anisaldehyde, 3-anisaldehyde and 4-anisaldehyde, most preferably the solvent is 4-anisaldehyde.

Alternatively, it may be preferred that R represents one substitution and that this substitution is OH.

As such, it is preferred that the solvent is selected from the group consisting of 2-hydroxybenzaldehyde (i.e. salicylaldehyde), 3-hydroxybenzaldehyde and 4-hydroxybenzaldehyde, most preferably the solvent is salicylaldehyde (i.e. 2-hydroxybenzaldehyde).

Alternatively it may be preferred that R represents one substitution and that this substitution is Me.

As such, it is preferred that the solvent is selected from the group consisting of 2-methylbenzaldehyde, 3-methylbenzaldehyde and 4-methylbenzaldehyde, most preferably the solvent is 4-methylbenzaldehyde.

Particularly preferred solvents according to formula (I) include benzaldehyde, 2-tolualdehyde, 3-tolualdehyde, 4-tolualdehyde, salicylaldehyde (i.e. 2-hydroxybenzaldehyde), 3-hydroxy benzaldehyde, 4-hydroxybenzaldehyde, 2-anisaldehyde (i.e. 2-methoxybenzaldehyde), 3-anisaldehyde, 4-anisaldehyde, 2-ethylbenzaldehyde, 3-ethylbenzaldehyde, 4-ethylbenzaldehyde, and 4-tertbutylbenzalydehyde.

In one embodiment, the solvent according to formula (I) is benzaldehyde. In another embodiment, the solvent according to formula (I) is 2-tolualdeyhde. In another embodiment, the solvent according to formula (I) is 3-tolualdeyhde. In another embodiment, the solvent according to formula (I) is 4-tolualdeyhde. In another embodiment, the solvent according to formula (I) is 2-hydroxybenzaldehyde. In another embodiment, the solvent according to formula (I) is 3-hydroxybenzaldehyde. In another embodiment, the solvent according to formula (I) is 4-hydroxybenzaldehyde. In another embodiment, the solvent according to formula (I) is 2-anisaldehyde. In another embodiment, the solvent according to formula (I) is 3-anisaldehyde. In another embodiment, the solvent according to formula (I) is 4-anisaldehyde. In another embodiment, the solvent according to formula (I) is 2-ethylbenzaldeyhde. In another embodiment, the solvent according to formula (I) is 3-ethylbenzaldeyhde. In another embodiment, the solvent according to formula (I) is 4-ethylbenzaldeyhde. In another embodiment, the solvent according to formula (I) is 4-tertbutylbenzaldeyhde.

Solvents having a structure according to formula (I) have a further advantage of having a pleasant smell. For example, 4-anisaldehyde has a sweet aniseed odor, 2-anisaldehyde has a licorice odor, vanillin (3-methoxy-4-hydroxybenzaldehade) has a vanilla odor, 4-tolualdehyde has a cherry-like odor, and benzaldehyde itself has an almond odor. These odors mean that the resulting emulsifiable concentrates (EC) and emulsions made therefrom are more pleasant to be used than many commercial amide-containing emulsifiable concentrate solvents, which typically have unpleasant fishy smells.

It is preferred that the solvent has a low water solubility, ensuring that an emulsion is formed, rather than a solution.

As such, it is preferred that the solvent has a water solubility of less than 1.00% w/w, more preferably of less than 0.50% w/w, most preferably of less than 0.30% w/w.

It is also preferred that the solvent has low phytotoxicity. This means that the presence of the solvent in the emulsifiable concentrate (EC), and in any emulsion-in-water (EW) formulations formed therefrom, does not cause plant damage, more specifically does not cause plant damage to soya plants.

In particular, it is preferred that the solvent has low phytotoxicity, wherein low phytotoxicity is defined as being when an emulsion containing 99.0% w/w, relative to the total weight of the emulsion, of water and 1.0% w/w, relative to the total weight of the emulsion, of a non-aqueous phase containing 90% w/w of the solvent, 7.5% w/w castor oil ethoxylate and 2.5% w/w of calcium dodecylbenzenesulfonate, each relative to the total weight of the non-aqueous phase, causes at no greater plant damage than an aqueous solution of 0.075% w/w castor oil ethoxylate and 0.025% w/w of calcium dodecylbenzenesulfonate, each relative to the total weight of the aqueous solution, when measured 14 days after application to soya plants at an application rate of 200 L per hectare.

This is especially important for agrochemical emulsifiable concentrates, since it improves the specificity of the resultant emulsion-in-water, when applied to crop plants. The pesticides can actively target the relevant pest (e.g. insects, fungus or weed plants), whilst the crop plant is not adversely affected.

The total content of solvents with a structure according to formula (I) is preferably in the range from 10 to 85% w/w, more preferably from 15 to 75% w/w, most preferably from 25 to 60% w/w, relative to the total weight of the emulsifiable concentrate (EC).

### The One or More Pesticides

Another essential component of the emulsifiable concentrate (EC) is one or more pesticides.

The one or more pesticides of the present invention are not limited.

Each of the one or more pesticides may be any substance, whether a chemical or biological agent, used to control pests, such as insecticides, herbicides, fungicides, acaricides, rodenticides, nematicides, and miticides.

Well known fungicides include the following categories:
A) Respiration inhibitors
B) Sterol biosynthesis inhibitors (SBI fungicides)
C) Nucleic acid synthesis inhibitors
D) Inhibitors of cell division and cytoskeleton
E) Inhibitors of amino acid and protein synthesis
F) Signal transduction inhibitors
G) Lipid and membrane synthesis inhibitors
H) Inhibitors with Multi Site Action
I) Cell wall synthesis inhibitors
J) Plant defence inducers
K) Unknown mode of action
L) Biopesticides

Examples of fungicides in categories A to L include:

### A) Respiration Inhibitors

Inhibitors of complex Ill at Qₒ site: azoxystrobin (A.1.1), coumethoxystrobin (A.1.2), coumoxystrobin (A.1.3), dimoxystrobin (A.1.4), enestroburin (A.1.5), fenaminstrobin (A.1.6), fenoxystrobin/flufenoxystrobin (A.1.7), fluoxastrobin (A.1.8), kresoxim-methyl (A.1.9), mandestrobin (A.1.10), metominostrobin (A.1.11), orysastrobin (A.1.12), picoxystrobin (A.1.13), pyraclostrobin (A.1.14), pyrametostrobin (A.1.15), pyraoxystrobin (A.1.16), trifloxystrobin (A.1.17), 2-(2-(3-(2,6-dichlorophenyl)-1-methyl-allylideneaminooxymethyl)-phenyl)-2-methoxyimino-N-methyl-acetamide (A.1.18), pyribencarb (A.1.19), triclopyricarb/chlorodincarb (A.1.20), famoxadone (A.1.21), fenamidone (A.1.21), methyl-N-[2-[(1,4-dimethyl-5-phenyl-pyrazol-3-yl)oxylmethyl]phenyl]-N-methoxy-carbamate (A.1.22), metyltetraprole (A.1.25), (?2E)-5-[1-(2,4-dichlorophenyl)pyrazol-3-yl]-oxy-2-methoxyimino-N,3-dimethyl-pent-3-enamide (A.1.34), (Z,2E)-5-[1-(4-chlorophenyl)pyrazol-3-yl]oxy-2-methoxyimino-N3-dimethyl-pent-3-enamide (A.1.35), pyriminostrobin (A.1.36), bifujunzhi (A.1.37), 2-(ortho-((2,5-dimethylphenyl-oxymethylen)phenyl)-3-methoxy-acrylic acid methylester (A.1.38);
inhibitors of complex Ill at Q, site: cyazofamid (A.2.1), amisulbrom (A.2.2), [(6S,7R,8R)-8-benzyl-3-[(3-hydroxy-4-methoxy-pyridine-2-carbonyl)amino]-6-methyl-4,9-di-oxo-1,5-dioxonan-7-yl]2-methylpropanoate (A.2.3), florylpicoxamid (A.2.4), metarylpicoxamid (A.2.5);
inhibitors of complex II: benodanil (A.3.1), benzovindiflupyr (A.3.2), bixafen (A.3.3), boscalid (A.3.4), carboxin (A.3.5), fenfuram (A.3.6), fluopyram (A.3.7), flutolanil (A.3.8), fluxapyroxad (A.3.9), furametpyr (A.3.10), isofetamid (A.3.11), isopyrazam (A.3.12), mepronil (A.3.13), oxycarboxin (A.3.14), penflufen (A.3.15), penthiopyrad (A.3.16), pydiflumetofen (A.3.17), pyraziflumid (A.3.18), sedaxane (A.3.19), tecloftalam (A.3.20), thifluzamide (A.3.21), inpyrfluxam (A.3.22), pyrapropoyne (A.3.23), fluindapyr (A.3.28), N-[2-[2-chloro-4-(trifluoro-methyl)phenoxy]phenyl]-3-(difluoromethyl)-5-fluoro-1-methyl-pyrazole-4-carboxamide (A.3.29), methyl (E)-2-[2-[(5-cyano-2-methyl-phenoxy)methyl]phenyl]-3-methoxy-prop-2-enoate (A.3.30), isoflucypram (A.3.31), 2-(difluoromethyl)-N-(1,1,3-trimethyl-indan-4-yl)-pyridine-3-carboxamide (A.3.32), 2-(difluoromethyl)-N-[(3R)-1,1,3-trimethylindan-4-yl]-pyridine-3-carboxamide (A.3.33), 2-(difluoromethyl)-N-(3-ethyl-1,1-dimethyl-indan-4-yl)-pyridine-3-carboxamide (A.3.34), 2-(difluoromethyl)-N-[(3R)-3-ethyl-1,1-dimethyl-indan-4-yl]-pyridine-3-carboxamide (A.3.35), 2-(difluoromethyl)-N-(1,1-dimethyl-3-propyl-indan-4-yl)pyridine-3-carboxamide (A.3.36), 2-(difluoromethyl)-N-[(3R)-1,1-dimethyl-3-propyl-indan-4-yl]-pyridine-3-carboxamide (A.3.37), 2-(difluoromethyl)-N-(3-isobutyl-1,1-dimethyl-indan-4-yl)-pyridine-3-carboxamide (A.3.38), 2-(difluoromethyl)-N-[(3R)-3-isobutyl-1,1-dimethyl-indan-4-yl]pyridine-3-carboxamide (A.3.39) cyclobutrifluram (A.3.24);
other respiration inhibitors: diflumetorim (A.4.1); nitrophenyl derivates: binapacryl (A.4.2), dinobuton (A.4.3), dinocap (A.4.4), fluazinam (A.4.5), meptyldinocap (A.4.6), ferimzone (A.4.7); organometal compounds: fentin salts, e.g. fentin-acetate (A.4.8), fentin chloride (A.4.9) or fentin hydroxide (A.4.10); ametoctradin (A.4.11); silthiofam (A.4.12);

### B) Sterol Biosynthesis Inhibitors (SBI Fungicides)

C14 demethylase inhibitors: triazoles: azaconazole (B.1.1), bitertanol (B.1.2), bromuconazole (B.1.3), cyproconazole (B.1.4), difenoconazole (B.1.5), diniconazole (B.1.6), diniconazole-M (B.1.7), epoxiconazole (8.1.8), fenbuconazole (B.1.9), fluquinconazole (8.1.10), flusilazole (B.1.11), flutriafol (B.1.12), hexaconazole (B.1.13), imibenconazole (B.1.14), ipconazole (B.1.15), metconazole (B.1.17), myclobutanil (B.1.18), oxpoconazole (B.1.19), paclobutrazole (B.1.20), penconazole (B.1.21), propiconazole (B.1.22), prothioconazole (B.1.23), simeconazole (B.1.24), tebuconazole (B.1.25), tetraconazole (B.1.26), triadimefon (B.1.27), triadimenol (B.1.28), triticonazole (B.1.29), uniconazole (B.1.30), 2-(2,4-difluorophenyl)-1,1-difluoro-3-(tetrazol-1-yl)-1-[5-[4-(2,2,2-trifluoroethoxy)phenyl]-2-pyridyl]propan-2-ol (B.1.31), 2-(2,4-difluorophenyl)-1,1-difluoro-3-(tetrazol-1-yl)-1-[5-[4-(trifluoromethoxy)phenyl]-2-pyridyl]propan-2-ol (B.1.32), fluoxytioconazole (B.1.33), ipfentrifluconazole (B.1.37), mefentrifluconazole (B.1.38), (2R)-2-[4-(4-chlorophenoxy)-2-(trifluoromethyl)phenyl]-1-(1,2,4-triazol-1-yl)propan-2-ol, (25)-2-[4-(4-chlorophenoxy)-2-(trifluoromethyl)phenyl]-1-(1,2,4-triazol-1-yl)propan-2-ol, 2-(chloromethyl)-2-methyl-5-(p-tolylmethyl)-1-(1,2,4-triazol-1-ylmethyl)cyclopentanol (B.1.43); imidazoles: imazalil (B.1.44), pefurazoate (B.1.45), prochloraz (B.1.46), triflumizol (B.1.47); pyrimidines, pyridines, piperazines: fenarimol (B.1.49), pyrifenox (B.1.50), triforine (B.1.51), [3-(4-chloro-2-fluoro-phenyl)-5-(2,4-difluorophenyl)isoxazol-4-yl]-(3-pyridyl)methanol (B.1.52), 4-[[6-[2-(2,4-difluorophenyl)-1,1-difluoro-2-hydroxy-3-(1,2,4-triazol-1-yl)propyl]-3-pyridyl]oxy]benzonitrile (B.1.53), 2-[6-(4-bromophenoxy)-2-(trifluoromethyl)-3-pyridyl]-1-(1,2,4-triazol-1-yl)propan-2-ol (B.1.54), 2-[6-(4-chlorophenoxy)-2-(trifluoromethyl)-3-pyridyl]-1-(1,2,4-triazol-1-yl)propan-2-ol (8.1.55), methyl 2-[2-chloro-4-(4-chlorophenoxy)phenyl]-2-hydroxy-3-(1,2,4-triazol-1-yl)propanoate (B.1.56), methyl 2-[2-chloro-4-(4-chlorophenoxy)phenyl]-2-hydroxy-3-(1,2,4-triazol-1-yl)propanoic acid (B.1.57);
Delta14-reductase inhibitors: aldimorph (B.2.1), dodemorph (B.2.2), dodemorph-acetate (B.2.3), fenpropimorph (B.2.4), tridemorph (B.2.5), fenpropidin (B.2.6), piperalin (B.2.7), spiroxamine (B.2.8);
Inhibitors of 3-keto reductase: fenhexamid (B.3.1);
Other Sterol biosynthesis inhibitors: chlorphenomizole (B.4.1);

### C) Nucleic Acid Synthesis Inhibitors

phenylamides or acyl amino acid fungicides: benalaxyl (C.1.1), benalaxyl-M (C.1.2), kiralaxyl (C.1.3), metalaxyl (C.1.4), metalaxyl-M (C.1.5), ofurace (C.1.6), oxadixyl (C.1.7); other nucleic acid synthesis inhibitors: hymexazole (C.2.1), octhilinone (C.2.2), oxolinic acid (C.2.3), bupirimate (C.2.4), 5-fluorocytosine (C.2.5), 5-fluoro-2-(p-tolylmethoxy)pyrimidin-4-amine (C.2.6), 5-fluoro-2-(4-fluorophenylmethoxy)pyrimidin-4-amine (C.2.7), 5-fluoro-2-(4-chlorophenylmethoxy)pyrimidin-4 amine (C.2.8);

### D) Inhibitors of Cell Division and Cytoskeleton

tubulin inhibitors: benomyl (D.1.1), carbendazim (D.1.2), fuberidazole (D1.3), thiabendazole (D.1.4), thiophanate-methyl (D.1.5), pyridachlometyl (D.1.6), N-ethyl-2-[(3-ethynyl-8-methyl-6-quinolyl)oxy]butanamide (D.1.8), N-ethyl-2-[(3-ethynyl-8-methyl-6-quinolyl)oxy]-2-methyl-sulfanyl-acetamide (D.1.9), 2-[(3-ethynyl-8-methyl-6-quinolyl)oxy]-N-(2-fluoroethyl)butan-amide (D.1.10), 2-[(3-ethynyl-8-methyl-6-quinolyl)oxy]-N-(2-fluoroethyl)-2-methoxy-acetamide (D.1.11), 2-[(3-ethynyl-8-methyl-6-quinolyl)oxy]-N-propyl-butanamide (D.1.12), 2-[(3-ethynyl-8-methyl-6-quinolyl)oxy]-2-methoxy-N-propyl-acetamide (D.1.13), 2-[(3-ethynyl-8-methyl-6-quinolyl)oxy]-2-methylsulfanyl-N-propyl-acetamide (D.1.14), 2-[(3-ethynyl-8-methyl-6-quinolyl)oxy]-N-(2-fluoroethyl)-2-methylsulfanyl-acetamide (D.1.15), 4-(2-bromo-4-fluoro-phenyl)-N-(2-chloro-6-fluoro-phenyl)-2,5-dimethyl-pyrazol-3-amine (D.1.16);
other cell division inhibitors: diethofencarb (D.2.1), ethaboxam (D.2.2), pencycuron (D.2.3), fluopicolide (D.2.4), zoxamide (D.2.5), metrafenone (D.2.6), pyriofenone (D.2.7), phenamacril (D.2.8);

### E) Inhibitors of Amino Acid and Protein Synthesis

methionine synthesis inhibitors: cyprodinil (E.1.1), mepanipyrim (E.1.2), pyrimethanil (E.1.3);
protein synthesis inhibitors: blasticidin-S(E.2.1), kasugamycin (E.2.2), kasugamycin hydro-chloride-hydrate (E.2.3), mildiomycin (E.2.4), streptomycin (E.2.5), oxytetracyclin (E.2.6);

### F) Signal Transduction Inhibitors

MAP/histidine kinase inhibitors: fluoroimid (F.1.1), iprodione (F.1.2), procymidone (F.1.3), vinclozolin (F.1.4), fludioxonil (F.1.5);
G protein inhibitors: quinoxyfen (F.2.1);

### G) Lipid and Membrane Synthesis Inhibitors

Phospholipid biosynthesis inhibitors: edifenphos (G.1.1), iprobenfos (G.1.2), pyrazophos (G.1.3), isoprothiolane (G.1.4);
lipid peroxidation: dicloran (G.2.1), quintozene (G.2.2), tecnazene (G.2.3), tolclofos-methyl (G.2.4), biphenyl (G.2.5), chloroneb (G.2.6), etridiazole (G.2.7), zinc thiazole (G.2.8);
phospholipid biosynthesis and cell wall deposition: dimethomorph (G.3.1), flumorph (G.3.2), mandipropamid (G.3.3), pyrimorph (G.3.4), benthiavalicarb (G.3.5), iprovalicarb (G.3.6), valifenalate (G.3.7);
compounds affecting cell membrane permeability and fatty acides: propamocarb (G.4.1);
inhibitors of oxysterol binding protein: oxathiapiprolin (G.5.1), fluoxapiprolin (G.5.3), 4-[1-[2-[3-(difluoromethyl)-5-methyl-pyrazol-1-yl]acetyl]-4-piperidyl]-N-tetralin-1-yl-pyridine-2-carboxamide (G.5.4), 4-[1-[2-[3,5-bis(difluoromethyl)pyrazol-1-yl]acetyl]-4-piperidyl]-N-tetralin-1-yl-pyridine-2-carboxamide (G.5.5), 4-[1-[2-[3-(difluoromethyl)-5-(trifluoromethyl)pyrazol-1-yl]acetyl]-4-piperidyl]-N-tetralin-1-yl-pyridine-2-carboxamide (G.5.6), 4-[1-[2-[5-cyclopropyl-3-(difluoromethyl)pyrazol-1-yl]acetyl]-4-piperidyl]-N-tetralin-1-yl-pyridine-2-carboxamide (G.5.7), 4-[1-[2-[5-methyl-3-(trifluoromethyl)pyrazol-1-yl]acetyl]-4-piperidyl]-N-tetralin-1-yl-pyridine-2-carboxamide (G.5.8), 4-[1-[2-[5-(difluoromethyl)-3-(trifluoromethyl)pyrazol-1-yl]acetyl]-4-piperidyl]-N-tetralin-1-yl-pyridine-2-carboxamide (G.5.9), 4-[1-[2-[3,5-bis(trifluoromethyl)pyrazol-1-yl]acetyl]-4-piperidyl]-N-tetralin-1-yl-pyridine-2-carboxamide (G.5.10), (4-[1-[2-[5-cyclopropyl-3-(trifluoromethyl)pyrazol-1-yl]acetyl]-4-piperidyl]-N-tetralin-1-yl-pyridine-2-carboxamide (G.5.11);
   H) Inhibitors with Multi Site Action
inorganic active substances: Bordeaux mixture (H.1.1), copper (H.1.2), copper acetate (H.1.3), copper hydroxide (H.1.4), copper oxychloride (H.1.5), basic copper sulfate (H.1.6), sulfur (H.1.7);
thio- and dithiocarbamates: ferbam (H.2.1), mancozeb (H.2.2), maneb (H.2.3), metam (H.2.4), metiram (H.2.5), propineb (H.2.6), thiram (H.2.7), zineb (H.2.8), ziram (H.2.9);
organochlorine compounds: anilazine (H.3.1), chlorothalonil (H.3.2), captafol (H.3.3), captan (H.3.4), folpet (H.3.5), dichlofluanid (H.3.6), dichlorophen (H.3.7), hexachlorobenzene (H.3.8), pentachlorphenole (H.3.9) and its salts, phthalide (H.3.10), tolylfluanid (H.3.11);
guanidines and others: guanidine (H.4.1), dodine (H.4.2), dodine free base (H.4.3), guazatine (H.4.4), guazatine-acetate (H.4.5), iminoctadine (H.4.6), iminoctadine-triacetate (H.4.7), iminoctadine-tris(albesilate) (H.4.8), dithianon (H.4.9), 2,6-dimethyl-1H,5H-[1,4]dithiino[2,3-c:5,6-c′]dipyrrole-1,3,5,7(2H,6H)-tetraone (H.4.10);

### I) Cell Wall Synthesis Inhibitors

inhibitors of glucan synthesis: validamycin (1.1.1), polyoxin B (1.1.2);
melanin synthesis inhibitors: pyroquilon (1.2.1), tricyclazole (1.2.2), carpropamid (1.2.3), dicyclomet (1.2.4), fenoxanil (1.2.5);

### J) Plant Defence Inducers

acibenzolar-S-methyl (J.1.1), probenazole (J.1.2), isotianil (J.1.3), tiadinil (J.1.4), prohexadione-calcium (J.1.5); phosphonates: fosetyl (J.1.6), fosetyl-aluminum (J.1.7), phosphorous acid and its salts (J.1.8), calcium phosphonate (J.1.11), potassium phosphonate (J.1.12), potassium or sodium bicarbonate (J.1.9), 4-cyclopropyl-N-(2,4-dimethoxyphenyl)thiadiazole-5-carboxamide (J.1.10);

### K) Unknown Mode of Action

bronopol (K.1.1), chinomethionat (K.1.2), cyflufenamid (K.1.3), cymoxanil (K.1.4), dazomet (K.1.5), debacarb (K.1.6), diclocymet (K.1.7), diclomezine (K.1.8), difenzoquat (K.1.9), difenzoquat-methylsulfate (K.1.10), diphenylamin (K.1.11), fenitropan (K.1.12), fenpyrazamine (K.1.13), flumetover (K.1.14), flumetylsulforim (K.1.60), flusulfamide (K.1.15), flutianil (K.1.16), harpin (K.1.17), methasulfocarb (K.1.18), nitrapyrin (K.1.19), nitrothal-isopropyl (K.1.20), tolprocarb (K.1.21), oxin-copper (K.1.22), proquinazid (K.1.23), seboctylamine (K.1.61), tebufloquin (K.1.24), tecloftalam (K.1.25), triazoxide (K.1.26), N′(4-(4-chloro-3-trifluoromethyl-phenoxy)-2,5-dimethyl-phenyl)-N-ethyl-N-methyl formamidine (K.1.27), N′-(4-(4-fluoro-3-trifluoromethyl-phenoxy)-2,5-dimethyl-phenyl)-N-ethyl-N-methyl formamidine (K.1.28), N′[4-[[3-[(4-chlorophenyl)methyl]-1,2,4-thiadiazol-5-yl]oxy]-2,5-dimethyl-phenyl]-N-ethyl-N-methyl-formamidine (K.1.29), N′(5-bromo-6-indan-2-yloxy-2-methyl-3-pyridyl)-N-ethyl-N-methyl-formamidine (K.1.30), N′[5-bromo-6-[1-(3,5-difluorophenyl)ethoxy]-2-methyl-3-pyridyl]-N-ethyl-N-methyl-formamidine (K.1.31), N′[5-bromo-6-(4-isopropylcyclohexoxy)-2-methyl-3-pyridyl]-N-ethyl-N-methyl-formamidine (K.1.32), N′[5-bromo-2-methyl-6-(1-phenylethoxy)-3-pyridyl]-N-ethyl-N-methyl-formamidine (K.1.33), N′(2-methyl-5-trifluoromethyl-4-(3-trimethylsilanyl-propoxy)-phenyl)-N-ethyl-N-methyl formamidine (K.1.34), N′(5-difluoromethyl-2-methyl-4-(3-trimethylsilanyl-propoxy)-phenyl)-N-ethyl-N-methyl formamidine (K.1.35), 2-(4-chloro-phenyl)-N-[4-(3,4-dimethoxy-phenyl)-isoxazol-5-yl]-2-prop-2-ynyloxy-acetamide (K.1.36), 3-[5-(4-chloro-phenyl)-2,3-dimethyl-isoxazolidin-3-yl]-pyridine (pyrisoxazole) (K.1.37), 3-[5-(4-methylphenyl)-2,3-dimethyl-isoxazolidin-3-yl]-pyridine (K.1.38), 5-chloro-1-(4,6-dimethoxy-pyrimidin-2-yl)-2-methyl-1H-benzoimidazole (K.1.39), ethyl (Z)-3-amino-2-cyano-3-phenyl-prop-2-enoate (K.1.40), picarbutrazox (K.1.41), pentyl N-[6-[[(Z)-[(1-methyltetrazol-5-yl)-phenyl-methylene]amino]oxymethyl]-2-pyridyl]carbamate (K.1.42), but-3-ynyl N-[6-[[(Z)-[(1-methyltetrazol-5-yl)-phenyl-methylene]amino]oxymethyl]-2-pyridyl]carbamate (K.1.43), ipflufenoquin (K.1.44), quinofumelin (K.1.47), benziothiazolinone (K.1.48), bromothalonil (K.1.49), 2-(6-benzyl-2-pyridyl)quinazoline (K.1.50), 2-[6-(3-fluoro-4-methoxy-phenyl)-5-methyl-2-pyridyl]quinazoline (K.1.51), dichlobentiazox (K.1.52), N′(2,5-dimethyl-4-phenoxy-phenyl)-N-ethyl-N-methyl-formamidine (K.1.53), aminopyrifen (K.1.54), fluopimomide (K.1.55), N-[5-bromo-2-methyl-6-(1-methyl-2-propoxy-ethoxy)-3-pyridyl]-N-ethyl-N-methyl-formamidine (K.1.56), N′-[4-(4,5-dichlorothiazol-2-yl)oxy-2,5-dimethyl-phenyl]-N-ethyl-N-methyl-formamidine (K.1.57), flufenoxadiazam (K.1.58), N-methyl-4-[5-(trifluoromethyl)-1,2,4-oxadiazol-3-yl]benzenecarbothioamide (K.1.59), N-methoxy-N-[[4-[5-(trifluoromethyl)-1,2,4-oxadiazol-3-yl]phenyl]methyl]cyclopropanecarboxamide (K.1.60; WO2018/177894, WO 2020/212513), N-((4-[5-(trifluoromethyl)-1,2,4-oxadiazol-3-yl]phenyl)methyl)propanamide (K.1.62), 3,3,3-trifluoro-N-[[3-fluoro-4-[5-(trifluoromethyl)-1,2,4-oxadiazol-3-yl]phenyl]methyl]propanamide (K.1.63), 3,3,3-trifluoro-N-[[2-fluoro-4-[5-(tri-fluoromethyl)-1,2,4-oxadiazol-3-yl]phenyl]methyl]propanamide (K.1.64), N-[2,3-difluoro-4-[5-(trifluoromethyl)-1,2,4-oxadiazol-3-yl]benzyl]butanamide (K.1.65), N-[[2,3-difluoro-4-[5-(trifluoromethyl)-1,2,4-oxadiazol-3-yl]phenyl]methyl]-3,3,3-trifluoro-propanamide (K.1.66), 1-methoxy-1-methyl-3-[[4-[5-(trifluoromethyl)-1,2,4-oxadiazol-3-yl]phenyl]methyl]-urea (K.1.67), 1,1-diethyl-3-[[4-[5-[trifluoromethyl]-1,2,4-oxadiazol-3-yl]phenyl]methyl]urea (K.1.68), N,2-dimethoxy-N-[[4-[5-(trifluoromethyl)-1,2,4-oxadiazol-3-yl]phenyl]methyl]propan-amide (K.1.69), N-ethyl-2-methyl-N-[[4-[5-(trifluoromethyl)-1,2,4-oxadiazol-3-yl]phenyl]meth-yl]propanamide (K.1.70), 1-methoxy-3-methyl-1-[[4-[5-(trifluoromethyl)-1,2,4-oxadiazol-3-yl]-phenyl]methyl]urea (K.1.71), 1-[[4-[5-(trifluoromethyl)-1,2,4-oxadiazol-3-yl]phenyl]methyl]pyrrolidin-2-one (K.1.72), 1-[[4-[5-(trifluoromethyl)-1,2,4-oxadiazol-3-yl]phenyl]methyl]piperidin-2-one (K.1.73), 4-[[4-[5-(trifluoromethyl)-1,2,4-oxadiazol-3-yl]phenyl]methyl]morpholin-3-one (K.1.74), 4,4-dimethyl-2-[[4-[5-(trifluoromethyl)-1,2,4-oxadiazol-3-yl]phenyl]methyl] isoxazolidin-3-one (K.1.75), 2-[[4-[5-(trifluoromethyl)-1,2,4-oxadiazol-3-yl]phenyl]methyl] isoxazolidin-3-one (K.1.76), 5,5-dimethyl-2-[[4-[5-(trifluoromethyl)-1,2,4-oxadiazol-3-yl]phenyl]methyl]-isoxazolidin-3-one (K.1.77), 3,3-dimethyl-1-[[4-[5-(trifluoromethyl)-1,2,4-oxadiazol-3-yl]phen-yl]methyl]piperidin-2-one (K.1.78), 2-[[4-[5-(trifluoromethyl)-1,2,4-oxadiazol-3-yl]phenyl]meth-yl]oxazinan-3-one (K.1.79), 1-[[3-fluoro-4-[5-(trifluoromethyl)-1,2,4-oxadiazol-3-yl]phenyl]-methyl]azepan-2-one (K.1.80), 4,4-dimethyl-1-[[4-[5-(trifluoromethyl)-1,2,4-oxadiazol-3-yl]-phenyl]methyl]pyrrolidin-2-one (K.1.81), 5-methyl-1-[[4-[5-(trifluoromethyl)-1,2,4-oxadiazol-3-yl]phenyl]methyl]pyrrolidin-2-one (K.1.82), ethyl 1-[[4-[5-(trifluoromethyl)-1,2,4-oxadiazol-3-yl]phenyl]methyl]pyrazole-4-carboxylate (K.1.83), N-methyl-1-[[4-[5-(trifluoromethyl)-1,2,4-oxadiazol-3-yl]phenyl]methyl]pyrazole-4-carboxamide (K.1.84), NN-dimethyl-1-[4-[5-(trifluoromethyl)-1,2,4-oxadiazol-3-yl]benzyl]-1H-1,2,4-triazol-3-amine (K.1.85), N-methoxy-N-methyl-1-[[4-[5-(trifluoromethyl)-1,2,4-oxadiazol-3-yl]phenyl]methyl]pyrazole-4-carboxamide (K.1.86), propyl-1-[[4-[5-(trifluoromethyl)-1,2,4-oxadiazol-3-yl]phenyl]methyl]-pyrazole-4-carboxamide (K.1.87), N-methoxy-1-[[4-[5-(trifluoromethyl)-1,2,4-oxadiazol-3-yl]phenyl]methyl]pyrazole-4-carboxamide (K.1.88), N-allyl-N-[[4-[5-(trifluoromethyl)-1,2,4-oxadiazol-3-yl]phenyl]methyl]propanamide (K.1.89), 3-ethyl-1-methoxy-1-[[4-[5-(tri-fluoromethyl)-1,2,4-oxadiazol-3-yl]phenyl]methyl]urea (K.1.90), 1,3-dimethoxy-1-[[4-[5-(tri-fluoromethyl)-1,2,4-oxadiazol-3-yl]phenyl]methyl]urea (K.1.91), N-allyl-N-[[4-[5-(trifluoro-methyl)-1,2,4-oxadiazol-3-yl]phenyl]methyl]acetamide (K.1.92), N-[4-[5-(trifluoromethyl)-1,2,4-oxadiazol-3-yl]benzyl]cyclopropanecarboxamide (K.1.93), 1-methyl-3-[[4-[5-(trifluoromethyl)-1,2,4-oxadiazol-3-yl]phenyl]methyl]urea (K.1.94), N′-[2-chloro-4-(2-fluorophenoxy)-5-methyl-phenyl]-N-ethyl-N-methyl-formamidine (K.1.95), N-[2-chloro-4-[(4-methoxy-phenyl)methyl]-5-methyl-phenyl]-N-ethyl-N-methyl-formamidine (K.1.96), N′-[2-chloro-4-[(4-cyano-phenyl)methyl]-5-methyl-phenyl]-N-ethyl-N-methyl-formamidine (K.1.97), N′-[2,5-dimethyl-4-(o-tolylmethyl)phenyl]-N-ethyl-N-methyl-formamidine (K.1.98), 6-chloro-3-(3-cyclopropyl-2-fluoro-phenoxy)-N-[2-(2,4-dimethylphenyl)-2,2-difluoro-ethyl]-5-methyl-pyridazine-4-carboxamide (K.1.99), 3-(3-bromo-2-fluoro-phenoxy)-6-chloro-N-[2-(2-chloro-4-methyl-phenyl)-2,2-difluoro-ethyl]-5-methyl-pyridazine-4-carboxamide (K.1.100), 6-chloro-N-[2-(2-chloro-4-methyl-phenyl)-2,2-difluoro-ethyl]-3-(3-cyclopropyl-2-fluoro-phenoxy)-5-methyl-pyridazine-4-carboxamide (K.1.101), 6-chloro-3-(3-cyclopropyl-2-fluoro-phenoxy)-N-[2-(3,4-dimethylphenyl)-2,2-difluoro-ethyl]-5-methyl-pyridazine-4-carboxamide (K.1.102), 6-chloro-3-(3-chloro-2-fluoro-phenoxy)-N-[2-(2,4-dimethylphenyl)-2,2-difluoro-ethyl]-5-methyl-pyridazine-4-carboxamide (K.1.103), N-[2-(2-bromo-4-methyl-phenyl)-2,2-difluoro-ethyl]-6-chloro-3-(3-cyclopropyl-2-fluoro-phenoxy)-5-methyl-pyridazine-4-carboxamide (K.1.104);

### L) Biopesticides

L1) Microbial pesticides with fungicidal, bactericidal, viricidal and/or plant defense activator activity: Ampelomyces quisqualis, Aspergillus flavus, Aureobasidium pullulans, Bacillus altitudinis, B. amyloliquefaciens, B. amyloliquefaciens ssp. plantarum (also referred to as B. velezensis), B. megaterium, B. mojavensis, B. mycoides, B. pumilus, B. simplex, B. solisalsi, B. subtilis, B. subtilis var. amyloliquefaciens, B. velezensis, Candida oleophila, C. saitoana, Clavibacter michiganensis (bacteriophages), Coniothyrium minitans, Cryphonectria parasitica, Cryptococcus albidus, Dilophosphora alopecuri Fusarium oxysporum, Cionostachys rosea f. catenulate (also named Gliocladium catenulatum), Gliocladium roseum, Lysobacter antibioticus, L. enzymogenes, Metschnikowia fructicola, Microdochium dimerum, Microsphaeropsis ochracea, Muscodor albus, Paenibacillus alvei, Paenibacillus epiphyticus, P. polymyxa, Pantoea vagans, Penicillium bilaiae, Phlebiopsis gigantea, Pseudomonas sp., Pseudomonas chloraphis, Pseudozyma flocculosa, Pichia anomala, Pythium oligandrum, Sphaerodes mycoparasitica, Streptomyces griseoviridis, S. lydicus, S. violaceusniger Talaromyces flavus, Trichoderma asperelloides, T. asperellum, T. atroviride, T. fertile, T. gamsii, T. harmatum, T. harzianum, T. polysporum, T. stromaticum, T. virens, T. viride, Typhula phacorrhiza, Ulocladium oudemansii Verticillium dahlia, zucchini yellow mosaic virus (avirulent strain);
L2) Biochemical pesticides with fungicidal, bactericidal, viricidal and/or plant defense activator activity: harpin protein, Reynoutria sachalinensis extract;
L3) Microbial pesticides with insecticidal, acaricidal, molluscidal and/or nematicidal activity: Agrobacterium radiobacter, Bacillus cereus, B. firmus, B. thuringiensis, B. thuringiensis ssp. aizawaf, B. t ssp. israelensis, B. t ssp. galleriae, B. t ssp. kurstaki; B. t ssp. tenebrionis, Beauveria bassiana, B. brongniartii Burkholderia spp., Chromobacterium subtsugae, Cydia pomonella granulovirus (CpGV), Cryptophlebia leucotreta granulovirus (CrleGV), Flavobacterium spp., Helicoverpa armigera nucleopolyhedrovirus (HearNPV), Helicoverpa zea nucleopolyhedrovirus (HzNPV), Helicoverpa zea single capsid nucleopolyhedrovirus (HzSNPV), Heterorhabditis bacteriophora, Isaria fumosorosea, Lecanicullium longisporum, L. muscarium, Metarhizium anisopliae, M. anisopliae var. anisopliae, M. anisopliae var. acridum, Nomuraea rileyi, Paecilomyces fumosoroseus, P. lilacinus, Paenibacillus popilliae, Pasteuria spp., P. nishizawae, P. penetrans, P. ramosa, P. thornea, P. usgae, Pseudomonas fluorescens, Spodoptera littoralis nucleopolyhedrovirus (SpliNPV), Steinernema carpocapsae, S. feltiae, S. kraussei, Streptomyces galbus, S. microflavus,
L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, cis-jasmone, 2-methyl 1-butanol, methyl eugenol, methyl jasmonate, (E,Z)-2,13-octadecadien-1-ol, (E,Z,Z)-2,13-octadecadien-1-ol acetate, (E,Z)-3,13-octadecadien-1-ol, (R)-1-octen-3-ol, pentatermanone, (E,Z,Z)-3,8,11-tetradecatrienyl acetate, (Z,E)-9,12-tetradecadien-1-yl acetate, (Z)-7-tetradecen-2-one, (Z)-9-tetradecen-1-yl acetate, (Z)-11-tetradecenal, (Z)-11-tetradecen-1-ol, extract of Chenopodium ambrosiodes, Neem oil, Quillay extract;
L5) Microbial pesticides with plant stress reducing, plant growth regulator, plant growth promoting and/or yield enhancing activity: Azospirillum amazonense, A. brasliense, A. lipoferum, A. irakense, A. halopraeferens, Bradyrhizobium spp., B. elkanii, B. japonicum, B. liaoningense, B. lupini, Delftia acidovorans, Glomus intraradices, Mesorhizobium spp., Rhizobium leguminosarum bv. phaseoli R. I. bv. trifolii R. I. bv. viciae, R. tropici Sinorhizobium meliloti,

Such fungicides, their preparation and their activity e.g. against harmful fungi is known (cf.: https://pesticidecompendium.bcpc.org/); these substances are commercially available. The compounds described by IUPAC nomenclature, their preparation and their pesticidal activity are also known (cf. Can. J. Plant Sci. 48(6), 587-94, 1968; EP-A 141 317; EP-A 152 031; EP-A 226 917; EP-A 243 970; EP-A 256 503; EP-A 428 941; EP-A 532 022; EP-A 1 028 125; EP-A 1 035 122; EP-A 1 201 648; EP-A 1122 244, JP 2002316902; DE 19650197; DE 10021412; DE 102005009458; U.S. Pat. Nos. 3,296,272; 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 10/139271, WO 11/028657, WO 12/168188, WO 07/006670, WO 11/77514; WO 13/047749, WO 10/069882, WO 13/047441, WO 03/16303, WO 09/90181, WO 13/007767, WO 13/010862, WO 13/127704, WO 13/024009, WO 13/24010, WO 13/047441, WO 13/162072, WO 13/092224, WO 11/135833, CN 1907024, CN 1456054, CN 103387541, CN 1309897, WO 12/84812, CN 1907024, WO 09094442, WO 14/60177, WO 13/116251, WO 08/013622, WO 15/65922, WO 94/01546, EP 2865265, WO 07/129454, WO 12/165511, WO 11/081174, WO 13/47441, WO 16/156241, WO 16/162265).

Well known insecticides include the following categories M.1 to M.UN

The following list M of pesticides, grouped according to the Mode of Action Classification of the Insecticide Resistance Action Committee (IRAC), together with which the compounds of the invention can be used and with which potential synergistic effects might be produced, illustrates the possible combinations:
M.1 AChE inhibitors
M.2. GABA-gated chloride channel antagonists
M.3 Sodium channel modulators
M.4 nAChR agonists
M.5 Nicotinic acetylcholine receptor allosteric activators
M.6 Chloride channel activators from the class of avermectins and milbemycins
M.7 Juvenile hormone mimics, such as hydroprene, kino-prene, methoprene
M.8 miscellaneous multi-site inhibitors
M.9 Chordotonal organ TRPV channel modulators
M.10 Mite growth inhibitors
M.11 Microbial disruptors of insect midgut membranes
M.12 Inhibitors of mitochondrial ATP synthase
M.13 Uncouplers of oxidative phosphorylation via disruption of the proton gradient
M.14 nAChR channel blockers
M.15 Inhibitors of the chitin biosynthesis type 0
M.16 Inhibitors of the chitin biosynthesis type 1
M.17 Moulting disruptors
M.18 Ecdyson receptor agonists
M.19 Octopamin receptor agonists
M.20 Mitochondrial complex Ill electron transport inhibitors
M.21 METI acaricides and insecticides
M.22 Voltage-dependent sodium channel blockers
M.23 Inhibitors of the of acetyl CoA carboxylase
M.24 Mitochondrial complex IV electron transport inhibitors
M.25 Mitochondrial complex II electron transport inhibitors
M.28 Ryanodine receptor-modulators
M.29: Chordotonal organ Modulators
M.30: broflanilide; fluxametamide, isocycloseram;
M.33 acynonapyr;
M.UN. Unknown mode of action

### Examples of Insecticides of Categories M.1 to M.UN Include:

M.1 AChE inhibitors: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate; acephate, azamethiphos, azinphos-ethyl, azinphosmethyl, cadusafos, chlorethoxyfos, chlorfenvinphos, chlormephos, chlorpyrifos, chlorpyrifosmethyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;
M.2. GABA-gated chloride channel antagonists: cyclodiene organochlorine compounds: endosulfan, chlordane; phenylpyrazoles: ethiprole, fipronil, flufiprole, pyrafluprole, pyriprole;
M.3 Sodium channel modulators: pyrethroids: acrinathrin, allethrin, d-cis-trans allethrin, d-trans allethrin, bifenthrin, kappa-bifenthrin, bioallethrin, bioallethrin S-cylclopentenyl, bio-resmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, heptafluthrin, imiprothrin, meperfluthrin, metofluthrin, momfluorothrin, epsilon-momfluorothrin, permethrin, phenothrin, prallethrin, profluthrin, pyrethrin (pyrethrum), resmethrin, silafluofen, tefluthrin, kappa-tefluthrin, tetramethylfluthrin, tetramethrin, tralomethrin, transfluthrin; sodium channel modulators, e.g.: DDT, methoxychlor;
M.4 nAChR agonists: neonicotinoids: acetamiprid, clothianidin, cycloxaprid, dinotefuran, imidacloprid, nitenpyram, thiacloprid, thiamethoxam; 4,5-dihydro-N-nitro-1-(2-oxiranylmethyl)-1H-imidazol-2-amine, (2E-)-1-[(6-Chloropyridin-3-yl)methyl]-N′-nitro-2-pentylidenehydrazinecarbox-imidamide; 1-[(6-Chloropyridin-3-yl)methyl]-7-methyl-8-nitro-5-propoxy-1,2,3,5,6,7-hexahydro-imidazo[1,2-a]pyridine; nicotine; sulfoxaflor; flupyradifurone; triflumezopyrim, fenmezoditiaz, flupyrimin;
M.5 Nicotinic acetylcholine receptor allosteric activators:spinosyns, e.g. spinosad or spineto-ram;
M.6 Chloride channel activators from the class of avermectins and milbemycins, e.g. abamectin, emamectin benzoate, ivermectin, lepimectin, or milbemectin;
M.7 Juvenile hormone mimics, such as hydroprene, kino-prene, methoprene; fenoxycarb, or pyriproxyfen;
M.8 miscellaneous multi-site inhibitors: CH₃Br, other alkyl halides, chloropicrin, sulfuryl fluoride, borax, tartar emetic;
M.9 Chordotonal organ TRPV channel modulators: afidopyropen, pymetrozine; pyrifluquinazon;
M.10 Mite growth inhibitors: clofentezine, hexythiazox, diflovidazin, etoxazole;
M.11 Microbial disruptors of insect midgut membranes: Bacillus thuringiensis, Bacillus sphaericus, and insecticdal proteins they produce e.g.: Bacillus thuringiensis subsp. israelensis, Bacillus sphaericus, Bacillus thuringiensis subsp. aizawai, Bacillus thuringiensis subsp. kurstaki; Bacillus thuringiensis subsp. tenebrionis, Bt crop proteins: Cry1Ab, Cry1Ac, Cry1Fa, Cry2Ab, mCry3A, Cry3Ab, Cry3Bb, Cry34/35Ab1;
M.12 Inhibitors of mitochondrial ATP synthase: diafenthiuron, organotin miticides, e.g.: azocyclotin, cyhexatin, fenbutatin oxide, propargite, tetradifon;
M.13 Uncouplers of oxidative phosphorylation via disruption of the proton gradient: chlorfenapyr, DNOC, sulfluramid;
M.14 nAChR channel blockers: nereistoxin analogues bensultap, cartap hydrochloride, thio-cyclam, thiosultap-sodium;
M.15 Inhibitors of the chitin biosynthesis type 0, e.g.: bistrifluron, chlorfluazuron, difluben-zuron, flucycloxuron, flufenoxuron, hexaflumuron, lufenuron, novaluron, noviflumuron, teflubenzuron, triflumuron;
M.16 Inhibitors of the chitin biosynthesis type 1: buprofezin;
M.17 Moulting disruptors: Dipteran, cyromazine;
M.18 Ecdyson receptor agonists, e.g.: methoxyfenozide, tebufenozide, halofenozide, fufenozide, chromafenozide;
M.19 Octopamin receptor agonists: amitraz;
M.20 Mitochondrial complex Ill electron transport inhibitors: hydramethylnon, acequinocyl, fluacrypyrim; bifenazate;
M.21 METI acaricides and insecticides, e.g.: fenazaquin, fenpyroximate, pyrimidifen, pyridaben, tebufenpyrad, tolfenpyrad, rotenone;
M.22 Voltage-dependent sodium channel blockers: indoxacarb, metaflumizone, 2-[2-(4-cyanophenyl)-1-[3-(trifluoromethyl)phenyl]¬ethylidene]-N-[4-(difluoromethoxy)phenyl]-hydrazine-carboxamide, N-(3-chloro-2-methyl¬phenyl)-2-[(4-chlorophenyl)[4-[methyl(methylsulfonyl)amino]phenyl]¬methylene]-hydrazinecarboxamide, N-[4-chloro-2-[[(1,1-dimethylethyl)amino]carbonyl]-6-methylphenyl]-1-(3-chloro-2-pyridinyl)-3-(fluoromethoxy)-1H-pyrazole-5-carboxamide, 2-[2-(4-cyanophenyl)-1-[3-(trifluoromethyl)phenyl]ethylidene]-N-[4-(difluoromethoxy)phenyl]-hydrazinecarboxamide;
M.23 Inhibitors of the of acetyl CoA carboxylase, e.g.: spirodiclofen, spiromesifen, spirotetramat; spiropidion; spirobudifen, 11-(4-chloro-2,6-dimethylphenyl)-12-hydroxy-1,4-dioxa-9-azadispiro[4.2.4.2]tetradec-11-en-10-one, spidoxamat:
M.24 Mitochondrial complex IV electron transport inhibitors: e.g. aluminium phosphide, calcium phosphide, zinc phosphide, cyanide;
M.25 Mitochondrial complex II electron transport inhibitors, e.g.: cyenopyrafen, cyflumetofen, cyetpyrafen, pyflubumide;
M.28 Ryanodine receptor-modulators: chlor¬antraniliprole, cyantraniliprole, cyclaniliprole, flubendiamide, fluchlordiniliprole, (R)-3-chloro-N1-{2-methyl-4-[1,2,2,2-tetrafluoro-1-(trifluoro-methyl)ethyl]phenyl}-N2-(1-methyl-2-methylsulfonylethyl)phthalamid, (S)-3-chloro-N1-{2-methyl-4-[1,2,2,2-tetrafluoro-1-(trifluoromethyl)ethyl]phenyl}-N2-(1-methyl-2-methylsulfonylethyl)phthal-amide, methyl-2-[3,5-dibromo-2-({[3-bromo-1-(3-chlorpyridin-2-yl)-1H-pyrazol-5-yl]carbonyl}amino)benzoyl]-1,2-dimethylhydrazine-carboxylate; N-[2-(5-amino-1,3,4-thiadiazol-2-yl)-4-chloro-6-methyl¬phenyl]-3-bromo-1-(3-chloro-2-pyridinyl)-1H-pyrazole-5-carboxamide; 3-chloro-1-(3-chloro-2-pyridinyl)-N-[2,4-dichloro-6-[[(1-cyano-1-methylethyl)amino]carbonyl]phenyl]-1H-pyrazole-5-carboxamide; tetrachlorantraniliprole; tetraniliprole; tiorantraniliprole; N-[4-chloro-2-[[(1,1-dimethylethyl)amino]carbonyl]-6-methyl-phenyl]-1-(3-chloro-2-pyridinyl)-3-(fluoromethoxy)-1H-pyrazole-5-carboxamide; cyhalodiamide; N-[2-(5-amino-1,3,4-thiadiazol-2-yl)-4-chloro-6-methylphenyl]-3-bromo-1-(3-chloro-2-pyridinyl)-1H-pyrazole-5-carboxamide;
M.29: Chordotonal organ Modulators: flonicamid;
M.30: broflanilide; fluxametamide, isocycloseram;
M.33 acynonapyr;
M.UN. Unknown mode of action: afoxolaner, azadirachtin, amidoflumet, ben-zoximate, bromopropylate, chino¬methionat, cryolite, cyproflanilid, dicloromezotiaz, dicofol, dimpropyridaz, flufenerim, flometoquin, fluensulfone, fluhexafon, fluopyram, fluralaner, metaldehyde, metoxadiazone, mivorilaner, modoflaner, piperonyl butoxide, pyridalyl, tioxazafen, trifluenfuronate, umifoxolaner, 11-(4-chloro-2,6-dimethylphenyl)-12-hydroxy-1,4-dioxa-9-azadispiro[4.2.4.2]-tetradec-11-en-10-one, 3-(4′-fluoro-2,4-dimethylbiphenyl-3-yl)-4-hydroxy-8-oxa-1-azaspiro[4.5]dec-3-en-2-one, 4-cyano-N-[2-cyano-5-[[[2,6-dibromo-4-[1,2,2,3,3,3-hexafluoro-1-(trifluoromethyl)propyl]phenyl]amino]carbonyl]phenyl]-2-methyl-benzamide, 4-cyano-3-[(4-cyano-2-methyl-benzoyl)amino]-N-[2,6-dichloro-4-[1,2,2,3,3,3-hexafluoro-1-(trifluoromethyl)propyl]phenyl]-2-fluoro-benzamide, N-[5-[[[2-chloro-6-cyano-4-[1,2,2,3,3,3-hexafluoro-1-(trifluoromethyl)propyl]phenyl]amino]carbonyl]-2-cyano-phenyl]-4-cyano-2-methyl-benzamide, N-[5-[[[2-bromo-6-chloro-4-[2,2,2-trifluoro-1-hydroxy-1-(trifluoro-methyl)ethyl]phenyl]amino]carbonyl]-2-cyano-phenyl]-4-cyano-2-methyl-benzamide, N-[5-[[[2-bromo-6-chloro-4-[1,2,2,3,3,3-hexafluoro-1-(trifluoromethyl)propyl]phenyl]amino]carbonyl]-2-cyano-phenyl]-4-cyano-2-methyl-benzamide, 4-cyano-N-[2-cyano-5-[[[2,6-dichloro-4-[1,2,2,3,3,3-hexafluoro-1-(trifluoromethyl)propyl]phenyl]amino]carbonyl]phenyl]-2-methyl-benz-amide, 1-[2-fluoro-4-methyl-5-[(2,2,2-trifluoroethyl)sulfinyl]phenyl]-3-(trifluoromethyl)-1H-1,2,4-triazole-5-amine, N-[5-[[[2-bromo-6-chloro-4-[1,2,2,2-tetrafluoro-1-(trifluoromethyl)ethyl]phenyl]amino]carbonyl]-2-cyano-phenyl]-4-cyano-2-methyl-benzamide, 4-cyano-N-[2-cyano-5-[[[2,6-dichloro-4-[1,2,2,2-tetrafluoro-1-(trifluoromethyl)ethyl]phenyl]amino]carbonyl]phenyl]-2-methyl-benzamide, actives on basis of Bacillus firmus (Votivo, 1-1582); fluazaindolizine; 5-[3-[2,6-dichloro-4-(3,3-dichloroallyloxy)phenoxy]propoxy]-1H-pyrazole; N-[5-[[2-bromo-6-chloro-4-[1,2,2,3,3,3-hexafluoro-1-(trifluoromethyl)-propyl]phenyl]carbamoyl]-2-cyano-phenyl]-4-cyano-2-methyl-benzamide; 4-cyano-N-[2-cyano-5-[[2,6-dichloro-4-[1,2,2,3,3,3-hexafluoro-1-(trifluoro-methyl)-propyl]phenyl]carbamoyl]phenyl]-2-methyl-benzamide; 4-cyano-N-[2-cyano-5-[[2,6-di-chloro-4-[1,2,2,2-tetrafluoro-1-(trifluoromethyl)ethyl]phenyl]carbamoyl]phenyl]-2-methyl-benz-amide; N-[5-[[2-bromo-6-chloro-4-[1,2,2,2-tetrafluoro-1-(trifluoromethyl)ethyl]phenyl]carba¬mo-yl]-2-cyano-phenyl]-4-cyano-2-methyl-benzamide;
2-(1,3-dioxan-2-yl)-6-[2-(3-pyridinyl)-5-thiazolyl]-pyridine; 2-[6-[2-(5-fluoro-3-pyridinyl)-5-thi-azo¬lyl]-2-pyridinyl]-pyrimidine; 2-[6-[2-(3-pyridinyl)-5-thiazolyl]-2-pyridinyl]-pyrimidine; N-methylsul-fonyl-6-[2-(3-pyridyl)thiazol-5-yl]pyridine-2-carboxamide; N-methylsulfonyl-6-[2-(3-pyridyl)thiazol-5-yl]pyridine-2-carboxamide; 1-[(6-chloro-3-pyridinyl)methyl]-1,2,3,5,6,7-hexa-hydro-5-methoxy-7-methyl-8-nitro-imidazo[1,2-a]pyridine; 1-[(6-chloropyridin-3-yl)methyl]-7-methyl-8-nitro-1,2,3,5,6,7-hexahydroimidazo[1,2-a]pyridin-5-ol; N-(3-chloro-2-methylphenyl)-2-[(4-chlorophenyl)[4-[methyl(methylsulfonyl)amino]phenyl]methylene]-hydrazinecarboxamide; 1-[(6-chloro-3-pyridinyl)methyl]-1,2,3,5,6,7-hexahydro-5-methoxy-7-methyl-8-nitro-imidazo[1,2-a]pyridine; 2-(3-pyridinyl)-N-(2-pyrimidinylmethyl)-2H-indazole-5-carboxamide; tyclopyrazoflor; sarolaner, lotilaner; N-[4-chloro-3-[[(phenylmethyl)amino]carbonyl]phenyl]-1-methyl-3-(1,1,2,2,2-pentafluoroethyl)-4-(trifluoromethyl)-1H-pyrazole-5-carboxamide; N-[4-chloro-3-[[(phenylmethyl)amino]carbonyl]phenyl]-1-methyl-3-(1,1,2,2,2-pentafluoroethyl)-4-(trifluoromethyl)-1H-pyrazole-5-carboxamide; 2-(3-ethylsulfonyl-2-pyridyl)-3-methyl-6-(tri-fluoromethyl)imidazo[4,5-b]pyridine, 2-[3-ethylsulfonyl-5-(trifluoromethyl)-2-pyridyl]-3-methyl-6-(trifluoromethyl)imidazo[4,5-b]pyridine; N-[4-chloro-3-(cyclopropylcarbamoyl)phenyl]-2-methyl-5-(1,1,2,2,2-pentafluoroethyl)-4-(trifluoromethyl)pyrazole-3-carboxamide, N-[4-chloro-3-[(1-cyanocyclopropyl)carbamoyl]phenyl]-2-methyl-5-(1,1,2,2,2-pentafluoroethyl)-4-(trifluoromethyl)pyrazole-3-carboxamide; benzpyrimoxan; tigolaner; oxazosulfyl; [(2S,3R,4R,5S,6S)-3,5-dimethoxy-6-methyl-4-propoxy-tetrahydropyran-2-yl]N-[4-[1-[4-(trifluoromethoxy)phenyl]-1,2,4-triazol-3-yl]phenyl]carbamate; [(2S,3R,4R,5S,6S)-3,4,5-trimethoxy-6-methyl-tetrahydropyran-2-yl]N-[4-[1-[4-(trifluoromethoxy)phenyl]-1,2,4-triazol-3-yl]phenyl]carbamate; [(2S,3R,4R,5S,6S)-3,5-dimethoxy-6-methyl-4-propoxy-tetrahydropyran-2-yl]N-[4-[1-[4-(1,1,2,2,2-pentafluoroethoxy)phenyl]-1,2,4-triazol-3-yl]phenyl]carbamate; [(2S,3R,4R,5S,6S)-3,4,5-trimethoxy-6-methyl-tetrahydropyran-2-yl]N-[4-[1-[4-(1,1,2,2,2-pentafluoroethoxy)phenyl]-1,2,4-triazol-3-yl]phenyl]carbamate; (2Z)-3-(2-isopropylphenyl)-2-[(E)-[4-[1-[4-(trifluoromethoxy)phenyl]-1,2,4-triazol-3-yl]phenyl]methylenehydrazono]thiazolidin-4-one, (2Z)-3-(2-isopropylphenyl)-2-[(E)-[4-[1-[4-(1,1,2,2,2-pentafluoroethoxy)phenyl]-1,2,4-triazol-3-yl]phenyl]methylenehydrazono]thiazolidin-4-one, (2Z)-3-(2-isopro¬pyl¬phenyl)-2-[(E)-[4-[1-[4-(1,1,2,2,2-pentafluoroethoxy)phenyl]-1,2,4-triazol-3-yl]phenyl]methylenehydrazono]thiazolidin-4-one; 2-(6-chloro-3-ethylsulfonyl-imidazo[1,2-a]pyridin-2-yl)-3-methyl-6-(trifluoromethyl)imidazo[4,5-b]pyridine, 2-(6-bromo-3-ethylsulfonyl-imidazo[1,2-a]pyridin-2-yl)-3-methyl-6-(trifluoromethyl)imidazo[4,5-b]pyridine, 2-(3-ethylsulfonyl-6-iodo-imidazo[1,2-a]pyridin-2-yl)-3-methyl-6-(trifluoromethyl)imidazo[4,5-b]pyridine, 2-(7-chloro-3-ethylsulfonyl-imidazo[1,2-a]pyridin-2-yl)-3-methyl-6-(trifluoromethyl)imidazo[4,5-b]pyridine, 2-(7-chloro-3-ethylsulfonyl-imidazo[1,2-a]pyridin-2-yl)-3-methyl-6-(trifluoromethyl)imidazo[4,5-b]pyridine, 2-(3-ethylsulfonyl-7-iodo-imidazo[1,2-a]pyridin-2-yl)-3-methyl-6-(trifluoromethyl)imidazo[4,5-b]pyridine, 3-ethylsulfonyl-6-iodo-2-[3-methyl-6-(trifluoromethyl)imidazo[4,5-b]pyridin-2-yl]imidazo[1,2-a]pyridine-8-carbonitrile, 2-[3-ethylsulfonyl-8-fluoro-6-(trifluoromethyl)imidazo[1,2-a]pyridin-2-yl]-3-methyl-6-(trifluoromethyl)imidazo[4,5-b]pyridine, 2-[3-ethylsulfonyl-7-(trifluoromethyl)imidazo[1,2-a]pyridin-2-yl]-3-methyl-6-(trifluoromethylsulfinyl)imidazo[4,5-b]pyridine, 2-[3-ethylsulfonyl-7-(trifluoromethyl)imidazo[1,2-a]pyridin-2-yl]-3-methyl-6-(trifluoromethyl)imidazo[4,5-c]pyridine, 2-(6-bromo-3-ethylsulfonyl-imidazo[1,2-a]pyridin-2-yl)-6-(trifluoromethyl)pyrazolo[4,3-c]pyridine; N-[[2-fluoro-4-[(2S,3S)-2-hydroxy-3-(3,4,5-trichlorophenyl)-3-(trifluoromethyl)pyrrolidin-1-yl]phenyl]methyl]cyclo-propanecarboxamide; 2-[2-fluoro-4-methyl-5-(2,2,2-trifluoroethylsulfinyl)phenyl]imino-3-(2,2,2-trifluoroethyl)thiazolidin-4-one; flupentiofenox, N-[3-chloro-1-(3-pyridyl)pyrazol-4-yl]-2-methyl-sulfonyl-propanamide, cyclobutrifluram; N-[4-chloro-3-[(1-cyanocyclopropyl)carbamoyl]phenyl]-2-methyl-4-methylsulfonyl-5-(1,1,2,2,2-pentafluoroethyl)pyrazole-3-carboxamide, cyproflanilide, nicofluprole; 1,4-dimethyl-2-[2-(pyridin-3-yl)-2 h-indazol-5-yl]-1,2,4-triazolidine-3,5-dione, 2-[2-fluoro-4-methyl-5-(2,2,2-trifluoroethylsulfanyl)phenyl]imino-3-(2,2,2-trifluoroethyl)thiazolidin-4-one, indazapyroxamet, N-[4-chloro-2-(3-pyridyl)thiazol-5-yl]-N-ethyl-3-methylsulfonyl-propanamide, N-cyclopropyl-5-[(5S)-5-(3,5-dichloro-4-fluoro-phenyl)-5-(trifluoromethyl)-4H-isoxazol-3-yl]isoquinoline-8-carboxamide, 5-[(5S)-5-(3,5-dichloro-4-fluoro-phenyl)-5-(trifluoromethyl)-4H-isoxazol-3-yl]-N-(pyrimidin-2-ylmethyl)isoquinoline-8-carboxamide, N-[1-(2,6-difluorophenyl)pyrazol-3-yl]-2-(trifluoromethyl)benzamide, 5-((1R,3R)-3-(3,5-Bis(trifluoromethyl)phenyl)-2,2-dichlorocyclopropane-1-carboxamido)-2-chloro-N-(3-(2,2-difluoroacetamido)-2,4-difluorophenyl)benzamide, 1-[6-(2,2-difluoro-7-methyl-[1,3]dioxolo[4,5-f]benzimidazol-6-yl)-5-ethylsulfonyl-3-pyridyl]cyclopropanecarbonitrile, 6-(5-cyclopropyl-3-ethylsulfonyl-2-pyridyl)-2,2-difluoro-7-methyl-[1,3]dioxolo[4,5-f]benzimidazole.

The commercially available compounds M listed above may be found in The Pesticide Manual, 18th Edition, C. MacBean, British Crop Protection Council (2018), or http://bcpcdata.com/pesticide-manual.html, http://www.alanwood.net/pesticides.
The active compounds described by IUPAC nomenclature are known from CN103814937; WO2013/003977, WO2007/101369, WO2018/177970, CN10171577, CN102126994, WO2007/101540, WO2007/043677, WO2011/085575, WO2008/134969, WO2012/034403, WO2006/089633, WO2008/067911, WO2006/043635, WO2009/124707, WO2013/050317, WO2010/060379, WO2010/127926, WO2010/006713, WO2012/000896, WO2007/101369, WO2012/143317, WO2015/038503, EP2910126, WO2015/059039, WO2015/190316, WO2012/126766, WO2009/102736, WO2013/116053, WO2018/052136, WO2015150252, WO2020055955, WO2021158455, WO2013092350, WO201811111, EP3608311, WO2019236274, WO2013092350, WO 2018052136, WO2009102736, WO2016174049, WO2012126766, CN106554335, WO2017054524, CN105153113, WO2022072650; WO2018071327, WO2022101502, WO2012158396, WO2007079162, WO2020013147.

Well known herbicides include the following categories b1) to b15):
b1) lipid biosynthesis inhibitors;
b2) acetolactate synthase inhibitors (ALS inhibitors);
b3) photosynthesis inhibitors;
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitosis inhibitors;
b10) inhibitors of the synthesis of very long chain fatty acids (VLCFA inhibitors);
b11) cellulose biosynthesis inhibitors;
b12) decoupler herbicides;
b13) auxinic herbicides;
b14) auxin transport inhibitors; and
b15) other herbicides

Examples of herbicides of groups b1) to b14) include:
b1) from the group of the lipid biosynthesis inhibitors:
ACC-herbicides such as alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, 4-(4′-Chloro-4-cyclo, propyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl¬[1,1′-biphenyl]-3-yl)-5,6-dihydro-2,2,6,6-tetramethyl-5-oxo-2H-pyran-3-yl carbonic acid methyl ester (CAS 1033760-58-5); and non ACC herbicides such as benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
b2) from the group of the ALS inhibitors:
sulfonylureas such as amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron,
imidazolinones such as imazamethabenz, imazamethabenz-methyl, imazamox, imazapic, imazapyr, imazaquin and imazethapyr, triazolopyrimidine herbicides and sulfonanilides such as cloransulam, cloransulam-methyl, diclosulam, flumetsulam, florasulam, metosulam, penoxsulam, pyrimisulfan and pyroxsulam,
pyrimidinylbenzoates such as bispyribac, bispyribac-sodium, pyribenzoxim, pyriftalid, pyriminobac, pyriminobac-methyl, pyrithiobac, pyrithiobac-sodium, 4-[[[2-[(4,6-dimethoxy-2-pyrimidinyl)oxy]phenyl]methyl]amino]-benzoic acid-1-methyl¬ethyl ester (CAS 420138-41-6), 4-[[[2-[(4,6-dimethoxy-2-pyrimidinyl)oxy]phenyl]¬methyl]amino]-benzoic acid propyl ester (CAS 420138-40-5), N-(4-bromophenyl)-2-[(4,6-dimethoxy-2-pyrimidinyl)oxy]benzenemethanamine (CAS 420138-01-8),
sulfonylaminocarbonyl-triazolinone herbicides such as flucarbazone, flucarbazone-sodium, propoxycarbazone, propoxycarbazone-sodium, thiencarbazone and thiencarbazone-methyl; and triafamone;
b3) from the group of the photosynthesis inhibitors:
amicarbazone, inhibitors of the photosystem II, 1-(6-tert-butylpyrimidin-4-yl)-2-hydroxy-4-methoxy-3-methyl-2H-pyrrol-5-one (CAS 1654744-66-7), 1-(5-tert-butylisoxazol-3-yl)-2-hydroxy-4-methoxy-3-methyl-2H-pyrrol-5-one (CAS 1637455-12-9), 1-(5-tert-butylisoxazol-3-yl)-4-chloro-2-hydroxy-3-methyl-2H-pyrrol-5-one (CAS 1637453-94-1), 1-(5-tert-butyl-1-methyl-pyrazol-3-yl)-4-chloro-2-hydroxy-3-methyl-2H-pyrrol-5-one (CAS 1654057-29-0), 1-(5-tert-butyl-1-methyl-pyrazol-3-yl)-3-chloro-2-hydroxy-4-methyl-2H-pyrrol-5-one (CAS 1654747-80-4), 4-hydroxy-1-methoxy-5-methyl-3-[4-(trifluoromethyl)-2-pyridyl]imidazolidin-2-one; (CAS 2023785-78-4), 4-hydroxy-1,5-dimethyl-3-[4-(trifluoromethyl)-2-pyridyl]imidazolidin-2-one (CAS 2023785-79-5), 5-ethoxy-4-hydroxy-1-methyl-3-[4-(trifluoromethyl)-2-pyridyl]imidazolidin-2-one (CAS 1701416-69-4), 4-hydroxy-1-methyl-3-[4-(trifluoromethyl)-2-pyridyl]imidazolidin-2-one (CAS 1708087-22-2), 4-hydroxy-1,5-dimethyl-3-[1-methyl-5-(trifluoromethyl)pyrazol-3-yl]imidazolidin-2-one (CAS 2023785-80-8), 1-(5-tert-butylisoxazol-3-yl)-4-ethoxy-5-hydroxy-3-methyl-imidazolidin-2-one (CAS 1844836-64-1), triazine herbicides, including of chlorotriazine, triazinones, triazindiones, methylthiotriazines and pyridazinones such as ametryn, atrazine, chloridazone, cyanazine, desmetryn, dimethametryn, hexazinone, metribuzin, prometon, prometryn, propazine, simazine, simetryn, terbumeton, terbuthylazin, terbutryn and trietazin, aryl urea such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates such as desmedipham, karbutilat, phenmedipham, phenmedipham-ethyl, nitrile herbicides such as bromofenoxim, bromoxynil and its salts and esters, ioxynil and its salts and esters, uraciles such as bromacil, lenacil and terbacil, and bentazon and bentazon-sodium, pyridate, pyridafol, pentanochlor and propanil and inhibitors of the photosystem I such as diquat, diquat-dibromide, paraquat, paraquat-dichloride and paraquat-dimetilsulfate.
b4) from the group of the protoporphyrinogen-IX oxidase inhibitors:
acifluorfen, acifluorfen-sodium, azafenidin, bencarbazone, benzfendizone, bifenox, butafenacil, carfentrazone, carfentrazone-ethyl, chlomethoxyfen, chlorphthalim, cinidon-ethyl, cyclopyranil, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, epyrifenacil, N-ethyl-3-(2,6-dichloro-4-trifluoro¬methylphenoxy)-5-methyl-1H-pyrazole-1-carboxamide (CAS 452098-92-9), N tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethyl, phenoxy)-5-methyl-1H-pyrazole-1-carboxamide (CAS 452099-05-7), N tetrahydro¬furfuryl-3-(2-chloro-6-fluoro-4-trifluoro¬methylphenoxy)-5-methyl-1H-pyrazole-1-carboxamide (CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), 1-methyl-6-trifluoro, methyl-3-(2,2,7-tri¬fluoro-3-oxo-4-prop-2-ynyl-3,4-dihydro-2H-benzo[1,4]oxazin-6-yl)-1H-pyrimidine-2,4-dione (CAS 1304113-05-0), methyl (E)-4-[2-chloro-5-[4-chloro-5-(difluoromethoxy)-1H-methyl-pyrazol-3-yl]-4-fluoro-phenoxy]-3-methoxy-but-2-enoate (CAS 948893-00-3), and 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4)
b5) from the group of the bleacher herbicides:
PDS inhibitors: beflubutamid, diflufenican, fluridone, flurochloridone, flurtamone, norflurazon, picolinafen, 4-(3-trifluoromethyl, phenoxy)-2-(4-trifluoromethylphenyl), pyrimidine (CAS 180608-33-7), rimisoxafen, HPPD inhibitors: benzobicyclon, benzofenap, bicyclopyrone, clomazone, fenquinotrione, isoxaflutole, mesotrione, oxotrione (CAS 1486617-21-3), pyrasulfotole, pyrazolynate, pyrazoxyfen, sulcotrione, tefuryltrione, tembotrione, tolpyralate, topramezone, bipyrazone, fenpyrazone, cypyrafluone, tripyrasulfone, benquitrione; bleacher, unknown target: aclonifen, amitrole flumeturon, 2-chloro-3-methylsulfanyl-N-(1-methyltetrazol-5-yl)-4-(trifluoromethyl)benzamide (CAS 1361139-71-0), bixlozone and 2-(2,5-dichlorophenyl)methyl-4,4-dimethyl-3-isoxazolidinone (CAS 81778-66-7)
b6) from the group of the EPSP synthase inhibitors:
glyphosate, glyphosate-isopropylammonium, glyposate-potassium and glyphosate-trimesium (sulfosate);
b7) from the group of the glutamine synthase inhibitors:
bilanaphos (bialaphos), bilanaphos-sodium, glufosinate, glufosinate-P and glufosinate-ammonium;
b8) from the group of the DHP synthase inhibitors:
asulam;
b9) from the group of the mitosis inhibitors:
compounds of group K1: dinitroanilines such as benfluralin, butralin, dinitramine, ethalfluralin, fluchloralin, oryzalin, pendimethalin, prodiamine and trifluralin, phosphoramidates such as amiprophos, amiprophos-methyl, and butamiphos, benzoic acid herbicides such as chlorthal, chlorthal-dimethyl, pyridines such as dithiopyr and thiazopyr, benzamides such as propyzamide and tebutam; compounds of group K2: carbetamide, chlorpropham, flamprop, flamprop-isopropyl, flamprop-methyl, flamprop-M-isopropyl, flamprop-M-methyl and propham
b10) from the group of the VLCFA inhibitors:
chloroacetamides such as acetochlor, alachlor, amidochlor, butachlor, dimethachlor, dimethenamid, dimethenamid-P, metazachlor, metolachlor, metolachlor-S, pethoxamid, pretilachlor, propachlor, propisochlor and thenylchlor, oxyacetanilides such as flufenacet and mefenacet, acetanilides such as diphenamid, naproanilide, napropamide and napropamide-M, tetrazolinones such fentrazamide, and other herbicides such as anilofos, cafenstrole, fenoxasulfone, ipfencarbazone, piperophos, pyroxasulfone, dimesulfazet and isoxazoline compounds of the formulae II.1, II.2, II.3, II.4, II.5, II.6, II.7, II.8 and II.9

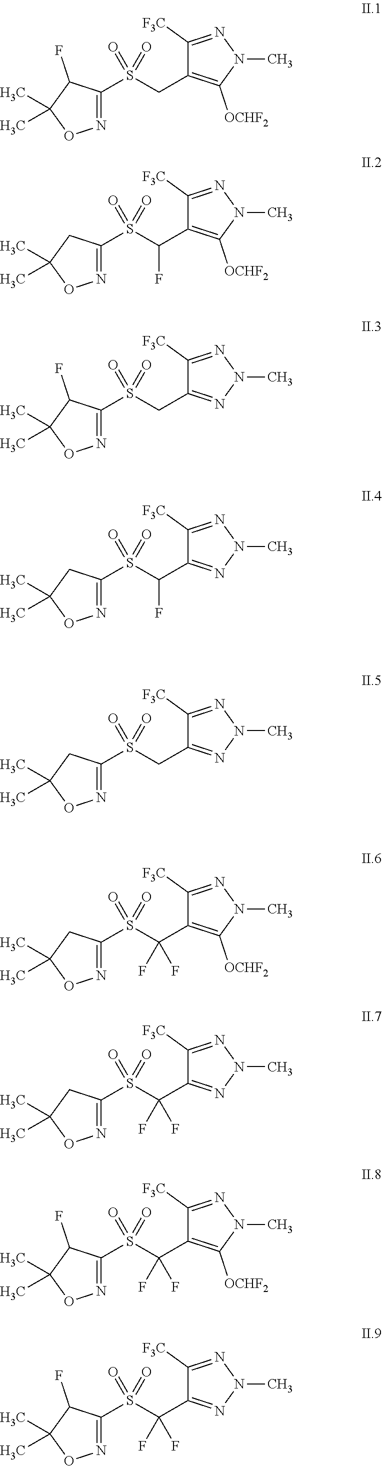

the isoxazoline compounds of the formula (II) are known in the art, e.g. from WO 2006/024820, WO 2006/037945, WO 2007/071900 and WO 2007/096576;
b11) from the group of the cellulose biosynthesis inhibitors:
chlorthiamid, dichlobenil, flupoxam, indaziflam, isoxaben, triaziflam and 1-cyclohexyl-5-pentafluorphenyloxy-14-[1,2,4,6]thiatriazin-3-ylamine (CAS 175899-01-1);
b12) from the group of the decoupler herbicides:
dinoseb, dinoterb and DNOC and its salts;
b13) from the group of the auxinic herbicides:
2,4-D and its salts and esters such as clacyfos, 2,4-DB and its salts and esters, aminocyclopyrachlor and its salts and esters, aminopyralid and its salts such as aminopyralid-dimethylammonium, aminopyralid-tris(2-hydroxypropyl)ammonium and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, flopyrauxifen, fluroxypyr, fluroxypyr-butometyl, fluroxypyr-meptyl, halauxifen and its salts and esters (CAS 943832-60-8); MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, florpyrauxifen, florpyrauxifen-benzyl (CAS 1390661-72-9) and 4-amino-3-chloro-5-fluoro-6-(7-fluoro-1H-indol-6-yl)picolinic acid (CAS 1629965-65-6)
b14) from the group of the auxin transport inhibitors: diflufenzopyr, diflufenzopyr-sodium, naptalam and naptalam-sodium;
b15) from the group of the other herbicides: bromobutide, chlorflurenol, chlorflurenol-methyl, cinmethylin, cumyluron, cyclopyrimorate and its salts and esters, dalapon, dazomet, difenzoquat, difenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, tridiphane, 6-chloro-4-(2,7-dimethyl-1-naphthyl)-5-hydroxy-2-methyl-pyridazin-3-one (CAS 2414510-21-5).

Furthermore, safeners (C), which are not themselves herbicidally active but can be used in combination with herbicides to protects crops without reducing the herbicidal effect of the weed during spraying (e.g. by helping the crop to metabolise the herbicide). Safeners are not always required, but may be helpful.

Safeners are chemical compounds which prevent or reduce damage on useful plants without having a major impact on the herbicidal action of the herbicidal active components of the present compositions towards unwanted plants. They can be applied either before sowings (e.g. on seed treatments, shoots or seedlings) or in the pre-emergence application or post-emergence application of the useful plant. The safeners and the herbicides B can be applied simultaneously or in succession.

Consequently, any of the above herbicides may be used in combination with a safener, preferably a safener selected from the list consisting of (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenyl¬carbamates and their agriculturally acceptable salts and their agriculturally acceptable derivatives such amides, esters, and thioesters, provided they have an acid group, benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4 (dichloroacetyl)-1-oxa-4-azaspiro[4.5]decane (MON4660, CAS 71526-07-3), 2,2,5-trimethyl-3-(dichloroacetyl)-1,3-oxazolidine (R 29148, CAS 52836-31 4), metcamifen and BPCMS (CAS 54091-06-4).

### Agriculturally Acceptable Salts

If the herbicidal compounds B and/or the safeners C as described herein have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

The active compounds B of groups b1) to b15) and the active compounds C are known herbicides and safeners, see, for example, The Compendium of Pesticide Common Names (http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998. 2,2,5-Trimethyl-3-(dichloroacetyl)-1,3-oxazolidine [CAS No. 52836-31-4] is also referred to as R-29148. 4-(Dichloroacetyl)-1-oxa-4-azaspiro[4.5]decane [CAS No. 71526-07-3] is also referred to as AD-67 and MON 4660.

The assignment of the active compounds to the respective mechanisms of action is based on current knowledge. If several mechanisms of action apply to one active compound, this substance was only assigned to one mechanism of action.

Suitable insecticides may preferably be selected from the group consisting of neonicotinoids, bisamides, benzoylureas and carbamates.

It is especially preferred that each insecticide is selected from fenoxycarb, piperonyl butoxide, imidacloprid, thiacloprid, acetamiprid, aldicarb, aldicarb sulfoxide, aldicarb sulfone, pirimicarb, chlorantraniliprole, terbufos, quinalphos, dyfonate, phosmet, carbaryl, etoxazole, thiamethoxam, flonicamid, etofenprox, phorate, profenofos, parathion, methylparathion, acephate, disulfoton, fenthion, fenvalerate, fipronil, baygon, methomyl, pymetrozine, oxamyl, tau-fluvalinate, cypermethrin, cyfluthrin, bifenthrin, tetramethrin, prallethrin (mix of isomers), permethrin (mix of isomers), resmethrin (mix of isomers), pyrethrin (mix of isomers), spinetoram (J), abamectin (mix of isomers), fenobucarb (BPMC), methiocarb, isoprocarb (MIPC), spirotetramat, Spinosad, trichlorfon, fenamiphos sulfoxide, fenamiphos sulfone, 3-hydroxycarbofuran, aldrin, DDE (p-p′), DDD (o-p), DDD (p-p′), DDE (o-p), DDT (o-p′), dieldrin, endrin, endrin aldehyde, endrin ketone, isodrin, chlordecone, or mirex (Dodecachlorooctahydro-1H-1,3,4-(epimethanetriyl)cyclobuta[cd]pentalene)

Suitable herbicides may preferably be selected from the group consisting of triazines and other photosystem 2 inhibitors, 2,6-dinitroanilines, ACCase inhibitors, PPO inhibitors, synthetic auxins, sulfonyl ureas, bipyrillium herbicides, chloroacetanilides, triazolopyrimidines, pyrazoles and herbicidal safeners.

It is especially preferred that each herbicide is selected from paclobutrazol, diuron, linuron, isoproturon, alachlor, pendimethalin, chlorpropham, fenoprop, bentazone, metolachlor, propazine, bromacil, 2,4-DB, fenoxaprop, fluometuron, molinate, cyanazine, simazine, atrazine, atrazine desethyl, or metribuzin.

Suitable fungicides may preferably be selected from the group consisting of pyrimidines, anilinopyrimidines, triazoles and other sterol demethylation inhibitors, triazolopyrimidines, MAP kinase inhibitors, strobilurins, adenosine deaminase inhibitors, pyrazoles and carboxamides.

It is especially preferred that each fungicide is selected from bitertanol, boscalid, bromuconazole, cyproconazole, diclobutrazole, diniconazole, epoxiconazole, etaconazole, fenbuconazole, fluquinconazole, flusilazole, flutriafol, hexaconazole, myclobutanil, penconazole, propiconazole, prothioconazole, tebuconazole, tetraconazole, triadimefon, triadimenol, triticonazole, 2-aminobutane, 8-hydroxyquinoline sulphate, 2-phenylphenol (OPP), aldi-morph, ampropylfos, anilazine, azoxystrobin, benalaxyl, benodanil, benomyl, binapacryl, biphenyl, blasticidin-S, bupirimate, buthiobate, calcium polysulphide, captafol, captan, carbendazim, carboxin, carpropamid, quinomethionate, chloroneb, chloropicrin, chlorothalonil, chlozolinate, cufraneb, cyazofamid, cymoxanil, cyprodinil, cyprofuram, dichlorophen, diclocymet, diclofluanid, diclomezin, dicloran, diethofencarb, diflumetorim, dimethirimol, dimethomorph, dinocap, diphenylamine, dipyrithion, ditalimfos, dithianon, dodine, drazoxolon, edifenphos, enestroburin, ethaboxam, ethirimol, etridiazole, famoxadone, fenamidone, fenarimol, fenfuram, fenhexamid, fenitropan, fenpiclonil, fenpropidin, fenpropimorph, fentin acetate, fentin hydroxide, ferbam, ferimzone, fluazinam, fludioxonil, flumorph, fluoromide, fluoxastrobin, flusulfamide, flutolanil, folpet, fosetyl-aluminium, fthalide, fuberidazole, furalaxyl, furmecyclox, guazatine, hexachlorobenzene, imazalil, iminoctadine, iprobenfos (IBP), iprodione, iprovalicarb, isoprothiolane, kasugamycin, copper preparations such as: copper hydroxide, copper naphthenate, copperoxychloride, copper sulphate, copper oxide, oxine-copper and Bordeaux mixture, mancopper, mancozeb, maneb, mepanipyrim, kresoxim-methyl, mepronil, metalaxyl, methasulfocarb, methfuroxam, metiram, metominostrobin, metrafenone, metsulfovax, myclobutanil, nickel dimethyldithiocarbamate, nitrothal-isopropyl, nuarimol, ofurace, oxadixyl, oxamocarb, oxycarboxin, pefurazoate, pencycuron, phosdiphen, picoxystrobin, pimaricin, piperalin, polyoxin, probenazole, prochloraz, procymidone, propamocarb, propineb, pyraclostrobin, pyrazophos, pyrifenox, pyrimethanil, pyroquilon, quinoxyfen, quintozene (PCNB), silthiofam, spiroxamine, sulphur and sulphur preparations, tecloftalam, tecnazene, thiabendazole, thicyofen, thifluzamide, thiophanate-methyl, thiram, tolclophos-methyl, tolylfluanid, triazoxide, trichlamide, tricyclazole, tridemorph, trifloxystrobin, triflumizole, triforine, validamycin, vinclozolin, zineb, ziram, or zoxamide.

Suitable acaricides may preferably be selected from tebufenpyrad, aldicard, azinphosmethyl, carbophenothion, dimethoate, dicrotophos, triazophos, malathion, phosalone, methidathion, hexythiazox, propargite, spirodiclofen, methamidophos, monocrotophos, phenthoate, pirimiphosmethyl, epn, dichlorvos, ethion, fenitrothion, diazinon, chlorpyriphos, oxydemeton methyl, pyridaben, fenpropathrin, bifenazate, spiromesifen, fenpyroximate (mix of isomers), acequinocyl, or carbofuran.

One suitable rodenticide is coumaphos.

One suitable nematicide is ethoprophos.

One suitable miticide is clofentezine.

In the context of agrochemical emulsifiable concentrates, the one or more pesticides are preferably selected from the group consisting of insecticides, herbicides, fungicides and combinations thereof, wherein the examples of each class of pesticide may be as defined above and below.

It is particularly preferred that least one of the one or more pesticides is selected from the group consisting of azoxystrobin, prothioconazole, pyraclostrobin, oxyfluorfen, diefenoconazole, trifloxystrobin, propiconazole, cyproconazole, flufenacetate, epoxiconazole, fluxopyroxad, fenbuconazole and tebuconazole.

It is a finding of the present invention that the solubility of each of these commercially important pesticides is generally improved in the solvent according to the present invention, when compared with typical solvent systems used for agrochemical emulsifiable concentrates, such as benzyl acetate, fatty acid dimethylamides and aromatic naphtha-based solvents.

It is thus preferred that the total pesticide content in the emulsifiable concentrate (EC) is in the range from 10 to 70% w/w, more preferably in the range from 20 to 65% w/w, most preferably in the range from 30 to 60% w/w, relative to the total weight of the emulsifiable concentrate (EQ.

Of these particularly preferred pesticides, azoxystrobin and prothioconazole are notoriously insoluble in the typical solvent systems described above.

It is a further finding of the present invention that the solubility of azoxystrobin and prothioconazole, in particular, are noticeably improved in the solvent according to the present invention, when compared with the typical solvent systems described above.

As such, in one embodiment, it is particularly preferred that one of the one or more pesticides is azoxystrobin or prothioconazole.

Preferably the combined content of azoxystrobin and prothioconazole in the emulsifiable concentrate (EC) according to this embodiment is in the range from 10 to 50% w/w, more preferably in the range from 13 to 40% w/w, most preferably in the range from 15 to 30% w/w, relative to the total weight of the emulsifiable concentrate (EC).

In the context of agrochemical emulsifiable concentrates, it is also well known that more than one pesticide may be used, resulting in a so-called combination formulation. Such combination formulations may have improved effects since the individual pesticides act in a synergistic manner or alternatively, the multiple pesticides may be active against different pests, for example, one pesticide may be a herbicide and another may be an insecticide.

In embodiment, the emulsifiable concentrate (EC) comprises two or more pesticides.

Many such combination formulations are commercially available and are well known in the field. As such, the choice of which combination of pesticides is selected is not particularly limited.

In a preferred embodiment, at least one, more preferably at least two, of the two or more pesticides is/are selected from the group consisting of azoxystrobin, prothioconazole, pyraclostrobin, oxyfluorfen, diefenoconazole, trifloxystrobin, propiconazole, cyproconazole, flufenacetate, epoxiconazole, fluxopyroxad, fenbuconazole and tebuconazole.

Particularly preferred combinations include azoxystrobin and cyproconazole, azoxystrobin and prothioconazole, cyproconazole and fencuconazole, and azoystrobin and tebuconazole.

### The One or More Emulsifiers

Another essential component of the emulsifiable concentrate (EC) is one or more emulsifiers.

The one or more emulsifiers of the present invention are not particularly limited. In its broadest form, the one or more emulsifiers may be selected from any conventional emulsifiers typically used in the field of agrochemical compositions and formulations.

For example, the one or more emulsifiers may be selected from:
products of the addition of 2 to 30 mol ethylene oxide and/or 0 to 5 mol propylene oxide onto linear C8-22 fatty alcohols, onto C12-22 fatty acids and onto alkyl phenols containing 8 to 15 carbon atoms in the alkyl group;
C12-18 fatty acid monoesters and diesters of addition products of 1 to 30 mol ethylene oxide onto glycerol;
glycerol mono- and diesters and sorbitan mono- and diesters of saturated and unsaturated fatty acids containing 6 to 22 carbon atoms and ethylene oxide addition products thereof
addition products of 15 to 60 mol ethylene oxide onto castor oil and/or hydrogenated castor oil;
polyol esters and, in particular, polyglycerol esters such as, for example, polyglycerol polyricinoleate, polyglycerol poly-12-hydroxystearate or polyglycerol dimerate isostearate;
addition products of 2 to 15 mol ethylene oxide onto castor oil and/or hydrogenated castor oil;
partial esters based on linear, branched, unsaturated or saturated C6-22 fatty acids, ricinoleic acid and 12-hydroxystearic acid and glycerol, polyglycerol, pentaerythritol, -dipentaerythritol, sugar alcohols (for example sorbitol), alkyl glucosides (for example methyl glucoside, butyl glucoside, lauryl glucoside) and polyglucosides (for example cellulose);
mono-, di and trialkyl phosphates and mono-, di- and/or tri-PEG-alkyl phosphates and salts thereof;
wool wax alcohols;
polysiloxane/polyalkyl polyether copolymers and corresponding derivatives;
mixed esters of pentaerythritol, fatty acids, citric acid and fatty alcohol and/or mixed esters of C6-22 fatty acids, methyl glucose and polyols, preferably glycerol or polyglycerol, and
polyalkylene glycols

The one or more emulsifiers are preferably selected from the group consisting of non-ionic emulsifiers, anionic emulsifiers and combinations thereof.

It is particularly preferred that at least one of the one or more emulsifiers is a non-ionic emulsifier.

It is also preferred that at least one of the one or more emulsifiers is an anionic emulsifier.

In one particularly preferred embodiment, the one or more emulsifiers comprises, more preferably consists of, a non-ionic emulsifier and an anionic emulsifier.

Suitable non-ionic emulsifiers may be selected from the group consisting of copolymers containing ethylene oxide and propylene oxide monomers, alcohol alkoxylates, alkyl polyglucosides, aminopolyols, polyalkylene glycols, alkoxylated animal or vegetable fats and oils such as corn oil ethoxylates, soybean oil ethoxylates, castor oil ethoxylates, tallow fatty ethoxylates, glycerol esters such as glycerol monostearate, fatty alcohol alkoxylates and oxoalcohol alkoxylates, fatty acid alkoxylates such as oleic acid ethoxylates, alkylphenol alkoxylates such as isononylphenol ethoxylates, fatty amine alkoxylates, fatty acid amide alkoxylates, sugar surfactants such as sorbitan fatty acid esters (e.g. sorbitan monooleate, and sorbitan tristearate), polyoxyethylene sorbitan fatty acid esters, alkyl polyglycosides, N-alkylgluconamides, alkylmethyl sulfoxides, alkyldimethylphosphine oxides such as tetradecyldimethylphosphine oxide, or combinations thereof.

It is preferred that at least one of the one or more emulsifiers is a copolymer containing ethylene oxide and propylene oxide monomers, more preferably is a block copolymer containing ethylene oxide and propylene oxide monomers.

Suitable anionic emulsifiers include salts wherein the anion may be selected from the group consisting of fatty acids, fatty alcohol ethersulfates, fatty alcohol sulfates, alkylbenzene sulfonates, ether phosphates, alkyl sulfates, alkyl ether sulfates, alkylsulfonates or iso-alkylsulfonates, alkylnaphthalenesulfonates, alkyl methyl ester sulfonates, acyl glutamates, alkylsulfosuccinates, sarcosinates, taurates and combinations thereof, whilst the cation may be selected from the group selected from alkali metal ions, alkaline earth metal ions, ammonium ions and combinations thereof.

It is preferred that at least one of the one or more emulsifiers is an alkyl benzene sulfonate, more preferably a linear alkylbenzene sulfonate.

In one especially preferred embodiment, the one or more emulsifiers comprises, more preferably consists of, a copolymer containing ethylene oxide and propylene oxide monomers and an alkylbenzene sulfonate. In this especially preferred embodiment, the copolymer containing ethylene oxide and propylene oxide monomers is more preferably a block copolymer containing ethylene oxide and propylene oxide monomers. The alkyl benzene sulfonate is likewise more preferably a linear alkylbenzene sulfonate.

The total content of the one or more emulsifiers in the emulsifiable concentrate (EC) is preferably in the range from 1 to 30% w/w, more preferably in the range from 5 to 20% w/w, most preferably in the range from 10 to 15% w/w, relative to the total weight of the emulsifiable concentrate (EC).

### The Emulsifiable Concentrate (EC)

As detailed above, the emulsifiable concentrate (EC) according to the present invention comprises one or more pesticides, one or more emulsifiers and one or more solvents as described above.

Particularly preferred combinations of one or more pesticides, one or more emulsifiers and one or more solvents are given in Table A:

| # | Pesticide(s) | Solvent(s) | Emulsifier(s) |
|---|---|---|---|
| 1 | P1 | S1 | E1 |
| 2 | P1 | S1 | E2 |
| 3 | P1 | S1 | E3 |
| 4 | P1 | S1 | E2 + E3 |
| 5 | P1 | S2 | E1 |
| 6 | P1 | S2 | E2 |
| 7 | P1 | S2 | E3 |
| 8 | P1 | S2 | E2 + E3 |
| 9 | P1 | S3 | E1 |
| 10 | P1 | S3 | E2 |
| 11 | P1 | S3 | E3 |
| 12 | P1 | S3 | E2 + E3 |
| 13 | P1 | S4 | E1 |
| 14 | P1 | S4 | E2 |
| 15 | P1 | S4 | E3 |
| 16 | P1 | S4 | E2 + E3 |
| 17 | P1 | S5 | E1 |
| 18 | P1 | S5 | E2 |
| 19 | P1 | S5 | E3 |
| 20 | P1 | S5 | E2 + E3 |
| 21 | P1 | S6 | E1 |
| 22 | P1 | S6 | E2 |
| 23 | P1 | S6 | E3 |
| 24 | P1 | S6 | E2 + E3 |
| 25 | P1 | S7 | E1 |
| 26 | P1 | S7 | E2 |
| 27 | P1 | S7 | E3 |
| 28 | P1 | S7 | E2 + E3 |
| 29 | P1 | S8 | E1 |
| 30 | P1 | S8 | E2 |
| 31 | P1 | S8 | E3 |
| 32 | P1 | S8 | E2 + E3 |
| 33 | P1 | S9 | E1 |
| 34 | P1 | S9 | E2 |
| 35 | P1 | S9 | E3 |
| 36 | P1 | S9 | E2 + E3 |
| 37 | P1 | S10 | E1 |
| 38 | P1 | S10 | E2 |
| 39 | P1 | S10 | E3 |
| 40 | P1 | S10 | E2 + E3 |
| 41 | P1 | S11 | E1 |
| 42 | P1 | S11 | E2 |
| 43 | P1 | S11 | E3 |
| 44 | P1 | S11 | E2 + E3 |
| 45 | P1 | S12 | E1 |
| 46 | P1 | S12 | E2 |
| 47 | P1 | S12 | E3 |
| 48 | P1 | S12 | E2 + E3 |
| 49 | P1 | S13 | E1 |
| 50 | P1 | S13 | E2 |
| 51 | P1 | S13 | E3 |
| 52 | P1 | S13 | E2 + E3 |
| 53 | P1 | S14 | E1 |
| 54 | P1 | S14 | E2 |
| 55 | P1 | S14 | E3 |
| 56 | P1 | S14 | E2 + E3 |
| 57 | P2 | S1 | E1 |
| 58 | P2 | S1 | E2 |
| 59 | P2 | S1 | E3 |
| 60 | P2 | S1 | E2 + E3 |
| 61 | P2 | S2 | E1 |
| 62 | P2 | S2 | E2 |
| 63 | P2 | S2 | E3 |
| 64 | P2 | S2 | E2 + E3 |
| 65 | P2 | S3 | E1 |
| 66 | P2 | S3 | E2 |
| 67 | P2 | S3 | E3 |
| 68 | P2 | S3 | E2 + E3 |
| 69 | P2 | S4 | E1 |
| 70 | P2 | S4 | E2 |
| 71 | P2 | S4 | E3 |
| 72 | P2 | S4 | E2 + E3 |
| 73 | P2 | S5 | E1 |
| 74 | P2 | S5 | E2 |
| 75 | P2 | S5 | E3 |
| 76 | P2 | S5 | E2 + E3 |
| 77 | P2 | S6 | E1 |
| 78 | P2 | S6 | E2 |
| 79 | P2 | S6 | E3 |
| 80 | P2 | S6 | E2 + E3 |
| 81 | P2 | S7 | E1 |
| 82 | P2 | S7 | E2 |
| 83 | P2 | S7 | E3 |
| 84 | P2 | S7 | E2 + E3 |
| 85 | P2 | S8 | E1 |
| 86 | P2 | S8 | E2 |
| 87 | P2 | S8 | E3 |
| 88 | P2 | S8 | E2 + E3 |
| 89 | P2 | S9 | E1 |
| 90 | P2 | S9 | E2 |
| 91 | P2 | S9 | E3 |
| 92 | P2 | S9 | E2 + E3 |
| 93 | P2 | S10 | E1 |
| 94 | P2 | S10 | E2 |
| 95 | P2 | S10 | E3 |
| 96 | P2 | S10 | E2 + E3 |
| 97 | P2 | S11 | E1 |
| 98 | P2 | S11 | E2 |
| 99 | P2 | S11 | E3 |
| 100 | P2 | S11 | E2 + E3 |
| 101 | P2 | S12 | E1 |
| 102 | P2 | S12 | E2 |
| 103 | P2 | S12 | E3 |
| 104 | P2 | S12 | E2 + E3 |
| 105 | P2 | S13 | E1 |
| 106 | P2 | S13 | E2 |
| 107 | P2 | S13 | E3 |
| 108 | P2 | S13 | E2 + E3 |
| 109 | P2 | S14 | E1 |
| 110 | P2 | S14 | E2 |
| 111 | P2 | S14 | E3 |
| 112 | P2 | S14 | E2 + E3 |
| 113 | P3 | S1 | E1 |
| 114 | P3 | S1 | E2 |
| 115 | P3 | S1 | E3 |
| 116 | P3 | S1 | E2 + E3 |
| 117 | P3 | S2 | E1 |
| 118 | P3 | S2 | E2 |
| 119 | P3 | S2 | E3 |
| 120 | P3 | S2 | E2 + E3 |
| 121 | P3 | S3 | E1 |
| 122 | P3 | S3 | E2 |
| 123 | P3 | S3 | E3 |
| 124 | P3 | S3 | E2 + E3 |
| 125 | P3 | S4 | E1 |
| 126 | P3 | S4 | E2 |
| 127 | P3 | S4 | E3 |
| 128 | P3 | S4 | E2 + E3 |
| 129 | P3 | S5 | E1 |
| 130 | P3 | S5 | E2 |
| 131 | P3 | S5 | E3 |
| 132 | P3 | S5 | E2 + E3 |
| 133 | P3 | S6 | E1 |
| 134 | P3 | S6 | E2 |
| 135 | P3 | S6 | E3 |
| 136 | P3 | S6 | E2 + E3 |
| 137 | P3 | S7 | E1 |
| 138 | P3 | S7 | E2 |
| 139 | P3 | S7 | E3 |
| 140 | P3 | S7 | E2 + E3 |
| 141 | P3 | S8 | E1 |
| 142 | P3 | S8 | E2 |
| 143 | P3 | S8 | E3 |
| 144 | P3 | S8 | E2 + E3 |
| 145 | P3 | 59 | E1 |
| 146 | P3 | S9 | E2 |
| 147 | P3 | S9 | E3 |
| 148 | P3 | S9 | E2 + E3 |
| 149 | P3 | S10 | E1 |
| 150 | P3 | S10 | E2 |
| 151 | P3 | S10 | E3 |
| 152 | P3 | S10 | E2 + E3 |
| 153 | P3 | S11 | E1 |
| 154 | P3 | S11 | E2 |
| 155 | P3 | S11 | E3 |
| 156 | P3 | S11 | E2 + E3 |
| 157 | P3 | S12 | E1 |
| 158 | P3 | S12 | E2 |
| 159 | P3 | S12 | E3 |
| 160 | P3 | S12 | E2 + E3 |
| 161 | P3 | S13 | E1 |
| 162 | P3 | S13 | E2 |
| 163 | P3 | S13 | E3 |
| 164 | P3 | S13 | E2 + E3 |
| 165 | P3 | S14 | E1 |
| 166 | P3 | S14 | E2 |
| 167 | P3 | S14 | E3 |
| 168 | P3 | S14 | E2 + E3 |
| 169 | P4 | S1 | E1 |
| 170 | P4 | S1 | E2 |
| 171 | P4 | S1 | E3 |
| 172 | P4 | S1 | E2 + E3 |
| 173 | P4 | S2 | E1 |
| 174 | P4 | S2 | E2 |
| 175 | P4 | S2 | E3 |
| 176 | P4 | S2 | E2 + E3 |
| 177 | P4 | S3 | E1 |
| 178 | P4 | S3 | E2 |
| 179 | P4 | S3 | E3 |
| 180 | P4 | S3 | E2 + E3 |
| 181 | P4 | S4 | E1 |
| 182 | P4 | S4 | E2 |
| 183 | P4 | S4 | E3 |
| 184 | P4 | S4 | E2 + E3 |
| 185 | P4 | S5 | E1 |
| 186 | P4 | S5 | E2 |
| 187 | P4 | S5 | E3 |
| 188 | P4 | S5 | E2 + E3 |
| 189 | P4 | S6 | E1 |
| 190 | P4 | S6 | E2 |
| 191 | P4 | S6 | E3 |
| 192 | P4 | S6 | E2 + E3 |
| 193 | P4 | S7 | E1 |
| 194 | P4 | S7 | E2 |
| 195 | P4 | S7 | E3 |
| 196 | P4 | S7 | E2 + E3 |
| 197 | P4 | S8 | E1 |
| 198 | P4 | S8 | E2 |
| 199 | P4 | S8 | E3 |
| 200 | P4 | S8 | E2 + E3 |
| 201 | P4 | S9 | E1 |
| 202 | P4 | S9 | E2 |
| 203 | P4 | S9 | E3 |
| 204 | P4 | S9 | E2 + E3 |
| 205 | P4 | S10 | E1 |
| 206 | P4 | S10 | E2 |
| 207 | P4 | S10 | E3 |
| 208 | P4 | S10 | E2 + E3 |
| 209 | P4 | S11 | E1 |
| 210 | P4 | S11 | E2 |
| 211 | P4 | S11 | E3 |
| 212 | P4 | S11 | E2 + E3 |
| 213 | P4 | S12 | E1 |
| 214 | P4 | S12 | E2 |
| 215 | P4 | S12 | E3 |
| 216 | P4 | S12 | E2 + E3 |
| 217 | P4 | S13 | E1 |
| 218 | P4 | S13 | E2 |
| 219 | P4 | S13 | E3 |
| 220 | P4 | S13 | E2 + E3 |
| 221 | P4 | S14 | E1 |
| 222 | P4 | S14 | E2 |
| 223 | P4 | S14 | E3 |
| 224 | P4 | S14 | E2 + E3 |
| 225 | P5 | S1 | E1 |
| 226 | P5 | S1 | E2 |
| 227 | P5 | S1 | E3 |
| 228 | P5 | S1 | E2 + E3 |
| 229 | P5 | S2 | E1 |
| 230 | P5 | S2 | E2 |
| 231 | P5 | S2 | E3 |
| 232 | P5 | S2 | E2 + E3 |
| 233 | P5 | S3 | E1 |
| 234 | P5 | S3 | E2 |
| 235 | P5 | S3 | E3 |
| 236 | P5 | S3 | E2 + E3 |
| 237 | P5 | S4 | E1 |
| 238 | P5 | S4 | E2 |
| 239 | P5 | S4 | E3 |
| 240 | P5 | S4 | E2 + E3 |
| 241 | P5 | S5 | E1 |
| 242 | P5 | S5 | E2 |
| 243 | P5 | S5 | E3 |
| 244 | P5 | S5 | E2 + E3 |
| 245 | P5 | S6 | E1 |
| 246 | P5 | S6 | E2 |
| 247 | P5 | S6 | E3 |
| 248 | P5 | S6 | E2 + E3 |
| 249 | P5 | S7 | E1 |
| 250 | P5 | S7 | E2 |
| 251 | P5 | S7 | E3 |
| 252 | P5 | S7 | E2 + E3 |
| 253 | P5 | S8 | E1 |
| 254 | P5 | S8 | E2 |
| 255 | P5 | S8 | E3 |
| 256 | P5 | S8 | E2 + E3 |
| 257 | P5 | S9 | E1 |
| 258 | P5 | S9 | E2 |
| 259 | P5 | S9 | E3 |
| 260 | P5 | S9 | E2 + E3 |
| 261 | P5 | S10 | E1 |
| 262 | P5 | S10 | E2 |
| 263 | P5 | S10 | E3 |
| 264 | P5 | S10 | E2 + E3 |
| 265 | P5 | S11 | E1 |
| 266 | P5 | S11 | E2 |
| 267 | P5 | S11 | E3 |
| 268 | P5 | S11 | E2 + E3 |
| 269 | P5 | S12 | E1 |
| 270 | P5 | S12 | E2 |
| 271 | P5 | S12 | E3 |
| 272 | P5 | S12 | E2 + E3 |
| 273 | P5 | S13 | E1 |
| 274 | P5 | S13 | E2 |
| 275 | P5 | S13 | E3 |
| 276 | P5 | S13 | E2 + E3 |
| 277 | P5 | S14 | E1 |
| 278 | P5 | S14 | E2 |
| 279 | P5 | S14 | E3 |
| 280 | P5 | S14 | E2 + E3 |
| 281 | P6 | S1 | E1 |
| 282 | P6 | S1 | E2 |
| 283 | P6 | S1 | E3 |
| 284 | P6 | S1 | E2 + E3 |
| 285 | P6 | S2 | E1 |
| 286 | P6 | S2 | E2 |
| 287 | P6 | S2 | E3 |
| 288 | P6 | S2 | E2 + E3 |
| 289 | P6 | S3 | E1 |
| 290 | P6 | S3 | E2 |
| 291 | P6 | 53 | E3 |
| 292 | P6 | S3 | E2 + E3 |
| 293 | P6 | S4 | E1 |
| 294 | P6 | S4 | E2 |
| 295 | P6 | S4 | E3 |
| 296 | P6 | S4 | E2 + E3 |
| 297 | P6 | S5 | E1 |
| 298 | P6 | S5 | E2 |
| 299 | P6 | S5 | E3 |
| 300 | P6 | S5 | E2 + E3 |
| 301 | P6 | S6 | E1 |
| 302 | P6 | S6 | E2 |
| 303 | P6 | S6 | E3 |
| 304 | P6 | S6 | E2 + E3 |
| 305 | P6 | S7 | E1 |
| 306 | P6 | S7 | E2 |
| 307 | P6 | S7 | E3 |
| 308 | P6 | S7 | E2 + E3 |
| 309 | P6 | S8 | E1 |
| 310 | P6 | S8 | E2 |
| 311 | P6 | S8 | E3 |
| 312 | P6 | S8 | E2 + E3 |
| 313 | P6 | S9 | E1 |
| 314 | P6 | S9 | E2 |
| 315 | P6 | S9 | E3 |
| 316 | P6 | S9 | E2 + E3 |
| 317 | P6 | S10 | E1 |
| 318 | P6 | S10 | E2 |
| 319 | P6 | S10 | E3 |
| 320 | P6 | S10 | E2 + E3 |
| 321 | P6 | S11 | E1 |
| 322 | P6 | S11 | E2 |
| 323 | P6 | S11 | E3 |
| 324 | P6 | S11 | E2 + E3 |
| 325 | P6 | S12 | E1 |
| 326 | P6 | S12 | E2 |
| 327 | P6 | S12 | E3 |
| 328 | P6 | S12 | E2 + E3 |
| 329 | P6 | S13 | E1 |
| 330 | P6 | S13 | E2 |
| 331 | P6 | S13 | E3 |
| 332 | P6 | S13 | E2 + E3 |
| 333 | P6 | S14 | E1 |
| 334 | P6 | S14 | E2 |
| 335 | P6 | S14 | E3 |
| 336 | P6 | S14 | E2 + E3 |
| 337 | P7 | S1 | E1 |
| 338 | P7 | S1 | E2 |
| 339 | P7 | S1 | E3 |
| 340 | P7 | S1 | E2 + E3 |
| 341 | P7 | S2 | E1 |
| 342 | P7 | S2 | E2 |
| 343 | P7 | S2 | E3 |
| 344 | P7 | S2 | E2 + E3 |
| 345 | P7 | S3 | E1 |
| 346 | P7 | S3 | E2 |
| 347 | P7 | S3 | E3 |
| 348 | P7 | S3 | E2 + E3 |
| 349 | P7 | S4 | E1 |
| 350 | P7 | S4 | E2 |
| 351 | P7 | S4 | E3 |
| 352 | P7 | S4 | E2 + E3 |
| 353 | P7 | S5 | E1 |
| 354 | P7 | S5 | E2 |
| 355 | P7 | S5 | E3 |
| 356 | P7 | S5 | E2 + E3 |
| 357 | P7 | S6 | E1 |
| 358 | P7 | S6 | E2 |
| 359 | P7 | S6 | E3 |
| 360 | P7 | S6 | E2 + E3 |
| 361 | P7 | S7 | E1 |
| 362 | P7 | S7 | E2 |
| 363 | P7 | S7 | E3 |
| 364 | P7 | S7 | E2 + E3 |
| 365 | P7 | S8 | E1 |
| 366 | P7 | S8 | E2 |
| 367 | P7 | S8 | E3 |
| 368 | P7 | S8 | E2 + E3 |
| 369 | P7 | S9 | E1 |
| 370 | P7 | S9 | E2 |
| 371 | P7 | S9 | E3 |
| 372 | P7 | S9 | E2 + E3 |
| 373 | P7 | S10 | E1 |
| 374 | P7 | S10 | E2 |
| 375 | P7 | S10 | E3 |
| 376 | P7 | S10 | E2 + E3 |
| 377 | P7 | S11 | E1 |
| 378 | P7 | S11 | E2 |
| 379 | P7 | S11 | E3 |
| 380 | P7 | S11 | E2 + E3 |
| 381 | P7 | S12 | E1 |
| 382 | P7 | S12 | E2 |
| 383 | P7 | S12 | E3 |
| 384 | P7 | S12 | E2 + E3 |
| 385 | P7 | S13 | E1 |
| 386 | P7 | S13 | E2 |
| 387 | P7 | S13 | E3 |
| 388 | P7 | S13 | E2 + E3 |
| 389 | P7 | S14 | E1 |
| 390 | P7 | S14 | E2 |
| 391 | P7 | S14 | E3 |
| 392 | P7 | S14 | E2 + E3 |
| 393 | P8 | S1 | E1 |
| 394 | P8 | S1 | E2 |
| 395 | P8 | S1 | E3 |
| 396 | P8 | S1 | E2 + E3 |
| 397 | P8 | S2 | E1 |
| 398 | P8 | S2 | E2 |
| 399 | P8 | S2 | E3 |
| 400 | P8 | S2 | E2 + E3 |
| 401 | P8 | S3 | E1 |
| 402 | P8 | S3 | E2 |
| 403 | P8 | S3 | E3 |
| 404 | P8 | S3 | E2 + E3 |
| 405 | P8 | S4 | E1 |
| 406 | P8 | S4 | E2 |
| 407 | P8 | S4 | E3 |
| 408 | P8 | S4 | E2 + E3 |
| 409 | P8 | S5 | E1 |
| 410 | P8 | S5 | E2 |
| 411 | P8 | S5 | E3 |
| 412 | P8 | S5 | E2 + E3 |
| 413 | P8 | S6 | E1 |
| 414 | P8 | S6 | E2 |
| 415 | P8 | S6 | E3 |
| 416 | P8 | S6 | E2 + E3 |
| 417 | P8 | S7 | E1 |
| 418 | P8 | S7 | E2 |
| 419 | P8 | S7 | E3 |
| 420 | P8 | S7 | E2 + E3 |
| 421 | P8 | S8 | E1 |
| 422 | P8 | S8 | E2 |
| 423 | P8 | S8 | E3 |
| 424 | P8 | S8 | E2 + E3 |
| 425 | P8 | S9 | E1 |
| 426 | P8 | S9 | E2 |
| 427 | P8 | S9 | E3 |
| 428 | P8 | S9 | E2 + E3 |
| 429 | P8 | S10 | E1 |
| 430 | P8 | S10 | E2 |
| 431 | P8 | S10 | E3 |
| 432 | P8 | S10 | E2 + E3 |
| 433 | P8 | S11 | E1 |
| 434 | P8 | S11 | E2 |
| 435 | P8 | S11 | E3 |
| 436 | P8 | S11 | E2 + E3 |
| 437 | P8 | S12 | E1 |
| 438 | P8 | S12 | E2 |
| 439 | P8 | S12 | E3 |
| 440 | P8 | S12 | E2 + E3 |
| 441 | P8 | S13 | E1 |
| 442 | P8 | S13 | E2 |
| 443 | P8 | S13 | E3 |
| 444 | P8 | S13 | E2 + E3 |
| 445 | P8 | S14 | E1 |
| 446 | P8 | S14 | E2 |
| 447 | P8 | S14 | E3 |
| 448 | P8 | S14 | E2 + E3 |
| 449 | P9 | S1 | E1 |
| 450 | P9 | S1 | E2 |
| 451 | P9 | S1 | E3 |
| 452 | P9 | S1 | E2 + E3 |
| 453 | P9 | S2 | E1 |
| 454 | P9 | S2 | E2 |
| 455 | P9 | S2 | E3 |
| 456 | P9 | S2 | E2 + E3 |
| 457 | P9 | S3 | E1 |
| 458 | P9 | S3 | E2 |
| 459 | P9 | S3 | E3 |
| 460 | P9 | S3 | E2 + E3 |
| 461 | P9 | S4 | E1 |
| 462 | P9 | S4 | E2 |
| 463 | P9 | S4 | E3 |
| 464 | P9 | S4 | E2 + E3 |
| 465 | P9 | S5 | E1 |
| 466 | P9 | S5 | E2 |
| 467 | P9 | S5 | E3 |
| 468 | P9 | S5 | E2 + E3 |
| 469 | P9 | S6 | E1 |
| 470 | P9 | 56 | E2 |
| 471 | P9 | S6 | E3 |
| 472 | P9 | S6 | E2 + E3 |
| 473 | P9 | S7 | E1 |
| 474 | P9 | S7 | E2 |
| 475 | P9 | S7 | E3 |
| 476 | P9 | S7 | E2 + E3 |
| 477 | P9 | S8 | E1 |
| 478 | P9 | S8 | E2 |
| 479 | P9 | S8 | E3 |
| 480 | P9 | S8 | E2 + E3 |
| 481 | P9 | S9 | E1 |
| 482 | P9 | S9 | E2 |
| 483 | P9 | S9 | E3 |
| 484 | P9 | S9 | E2 + E3 |
| 485 | P9 | S10 | E1 |
| 486 | P9 | S10 | E2 |
| 487 | P9 | S10 | E3 |
| 488 | P9 | S10 | E2 + E3 |
| 489 | P9 | S11 | E1 |
| 490 | P9 | S11 | E2 |
| 491 | P9 | S11 | E3 |
| 492 | P9 | S11 | E2 + E3 |
| 493 | P9 | S12 | E1 |
| 494 | P9 | S12 | E2 |
| 495 | P9 | S12 | E3 |
| 496 | P9 | S12 | E2 + E3 |
| 497 | P9 | S13 | E1 |
| 498 | P9 | S13 | E2 |
| 499 | P9 | S13 | E3 |
| 500 | P9 | S13 | E2 + E3 |
| 501 | P9 | S14 | E1 |
| 502 | P9 | S14 | E2 |
| 503 | P9 | S14 | E3 |
| 504 | P9 | S14 | E2 + E3 |
| 505 | P10 | S1 | E1 |
| 506 | P10 | S1 | E2 |
| 507 | P10 | S1 | E3 |
| 508 | P10 | S1 | E2 + E3 |
| 509 | P10 | S2 | E1 |
| 510 | P10 | S2 | E2 |
| 511 | P10 | S2 | E3 |
| 512 | P10 | S2 | E2 + E3 |
| 513 | P10 | S3 | E1 |
| 514 | P10 | S3 | E2 |
| 515 | P10 | S3 | E3 |
| 516 | P10 | S3 | E2 + E3 |
| 517 | P10 | S4 | E1 |
| 518 | P10 | S4 | E2 |
| 519 | P10 | S4 | E3 |
| 520 | P10 | S4 | E2 + E3 |
| 521 | P10 | S5 | E1 |
| 522 | P10 | S5 | E2 |
| 523 | P10 | S5 | E3 |
| 524 | P10 | S5 | E2 + E3 |
| 525 | P10 | S6 | E1 |
| 526 | P10 | S6 | E2 |
| 527 | P10 | S6 | E3 |
| 528 | P10 | S6 | E2 + E3 |
| 529 | P10 | S7 | E1 |
| 530 | P10 | S7 | E2 |
| 531 | P10 | S7 | E3 |
| 532 | P10 | S7 | E2 + E3 |
| 533 | P10 | S8 | E1 |
| 534 | P10 | S8 | E2 |
| 535 | P10 | S8 | E3 |
| 536 | P10 | S8 | E2 + E3 |
| 537 | P10 | S9 | E1 |
| 538 | P10 | S9 | E2 |
| 539 | P10 | S9 | E3 |
| 540 | P10 | S9 | E2 + E3 |
| 541 | P10 | S10 | E1 |
| 542 | P10 | S10 | E2 |
| 543 | P10 | S10 | E3 |
| 544 | P10 | S10 | E2 + E3 |
| 545 | P10 | S11 | E1 |
| 546 | P10 | S11 | E2 |
| 547 | P10 | S11 | E3 |
| 548 | P10 | S11 | E2 + E3 |
| 549 | P10 | S12 | E1 |
| 550 | P10 | S12 | E2 |
| 551 | P10 | S12 | E3 |
| 552 | P10 | S12 | E2 + E3 |
| 553 | P10 | S13 | E1 |
| 554 | P10 | S13 | E2 |
| 555 | P10 | S13 | E3 |
| 556 | P10 | S13 | E2 + E3 |
| 557 | P10 | S14 | E1 |
| 558 | P10 | S14 | E2 |
| 559 | P10 | S14 | E3 |
| 560 | P10 | S14 | E2 + E3 |
| 561 | P11 | S1 | E1 |
| 562 | P11 | S1 | E2 |
| 563 | P11 | S1 | E3 |
| 564 | P11 | S1 | E2 + E3 |
| 565 | P11 | S2 | E1 |
| 566 | P11 | S2 | E2 |
| 567 | P11 | S2 | E3 |
| 568 | P11 | S2 | E2 + E3 |
| 569 | P11 | S3 | E1 |
| 570 | P11 | S3 | E2 |
| 571 | P11 | S3 | E3 |
| 572 | P11 | S3 | E2 + E3 |
| 573 | P11 | S4 | E1 |
| 574 | P11 | S4 | E2 |
| 575 | P11 | S4 | E3 |
| 576 | P11 | S4 | E2 + E3 |
| 577 | P11 | S5 | E1 |
| 578 | P11 | S5 | E2 |
| 579 | P11 | S5 | E3 |
| 580 | P11 | S5 | E2 + E3 |
| 581 | P11 | S6 | E1 |
| 582 | P11 | S6 | E2 |
| 583 | P11 | S6 | E3 |
| 584 | P11 | S6 | E2 + E3 |
| 585 | P11 | S7 | E1 |
| 586 | P11 | S7 | E2 |
| 587 | P11 | S7 | E3 |
| 588 | P11 | S7 | E2 + E3 |
| 589 | P11 | S8 | E1 |
| 590 | P11 | S8 | E2 |
| 591 | P11 | S8 | E3 |
| 592 | P11 | S8 | E2 + E3 |
| 593 | P11 | S9 | E1 |
| 594 | P11 | S9 | E2 |
| 595 | P11 | S9 | E3 |
| 596 | P11 | S9 | E2 + E3 |
| 597 | P11 | S10 | E1 |
| 598 | P11 | S10 | E2 |
| 599 | P11 | S10 | E3 |
| 600 | P11 | S10 | E2 + E3 |
| 601 | P11 | S11 | E1 |
| 602 | P11 | S11 | E2 |
| 603 | P11 | S11 | E3 |
| 604 | P11 | S11 | E2 + E3 |
| 605 | P11 | S12 | E1 |
| 606 | P11 | S12 | E2 |
| 607 | P11 | S12 | E3 |
| 608 | P11 | S12 | E2 + E3 |
| 609 | P11 | S13 | E1 |
| 610 | P11 | S13 | E2 |
| 611 | P11 | S13 | E3 |
| 612 | P11 | S13 | E2 + E3 |
| 613 | P11 | S14 | E1 |
| 614 | P11 | S14 | E2 |
| 615 | P11 | S14 | E3 |
| 616 | P11 | S14 | E2 + E3 |
| 617 | P12 | S1 | E1 |
| 618 | P12 | S1 | E2 |
| 619 | P12 | S1 | E3 |
| 620 | P12 | S1 | E2 + E3 |
| 621 | P12 | S2 | E1 |
| 622 | P12 | S2 | E2 |
| 623 | P12 | S2 | E3 |
| 624 | P12 | S2 | E2 + E3 |
| 625 | P12 | S3 | E1 |
| 626 | P12 | S3 | E2 |
| 627 | P12 | S3 | E3 |
| 628 | P12 | S3 | E2 + E3 |
| 629 | P12 | S4 | E1 |
| 630 | P12 | S4 | E2 |
| 631 | P12 | S4 | E3 |
| 632 | P12 | S4 | E2 + E3 |
| 633 | P12 | S5 | E1 |
| 634 | P12 | S5 | E2 |
| 635 | P12 | S5 | E3 |
| 636 | P12 | S5 | E2 + E3 |
| 637 | P12 | S6 | E1 |
| 638 | P12 | S6 | E2 |
| 639 | P12 | S6 | E3 |
| 640 | P12 | S6 | E2 + E3 |
| 641 | P12 | S7 | E1 |
| 642 | P12 | S7 | E2 |
| 643 | P12 | S7 | E3 |
| 644 | P12 | S7 | E2 + E3 |
| 645 | P12 | S8 | E1 |
| 646 | P12 | S8 | E2 |
| 647 | P12 | S8 | E3 |
| 648 | P12 | S8 | E2 + E3 |
| 649 | P12 | S9 | E1 |
| 650 | P12 | S9 | E2 |
| 651 | P12 | S9 | E3 |
| 652 | P12 | S9 | E2 + E3 |
| 653 | P12 | S10 | E1 |
| 654 | P12 | S10 | E2 |
| 655 | P12 | S10 | E3 |
| 656 | P12 | S10 | E2 + E3 |
| 657 | P12 | S11 | E1 |
| 658 | P12 | S11 | E2 |
| 659 | P12 | S11 | E3 |
| 660 | P12 | S11 | E2 + E3 |
| 661 | P12 | S12 | E1 |
| 662 | P12 | S12 | E2 |
| 663 | P12 | S12 | E3 |
| 664 | P12 | S12 | E2 + E3 |
| 665 | P12 | S13 | E1 |
| 666 | P12 | S13 | E2 |
| 667 | P12 | S13 | E3 |
| 668 | P12 | S13 | E2 + E3 |
| 669 | P12 | S14 | E1 |
| 670 | P12 | S14 | E2 |
| 671 | P12 | S14 | E3 |
| 672 | P12 | S14 | E2 + E3 |
| 673 | P13 | S1 | E1 |
| 674 | P13 | S1 | E2 |
| 675 | P13 | S1 | E3 |
| 676 | P13 | S1 | E2 + E3 |
| 677 | P13 | S2 | E1 |
| 678 | P13 | S2 | E2 |
| 679 | P13 | S2 | E3 |
| 680 | P13 | S2 | E2 + E3 |
| 681 | P13 | S3 | E1 |
| 682 | P13 | S3 | E2 |
| 683 | P13 | S3 | E3 |
| 684 | P13 | S3 | E2 + E3 |
| 685 | P13 | S4 | E1 |
| 686 | P13 | S4 | E2 |
| 687 | P13 | S4 | E3 |
| 688 | P13 | S4 | E2 + E3 |
| 689 | P13 | S5 | E1 |
| 690 | P13 | S5 | E2 |
| 691 | P13 | S5 | E3 |
| 692 | P13 | S5 | E2 + E3 |
| 693 | P13 | S6 | E1 |
| 694 | P13 | S6 | E2 |
| 695 | P13 | S6 | E3 |
| 696 | P13 | S6 | E2 + E3 |
| 697 | P13 | S7 | E1 |
| 698 | P13 | S7 | E2 |
| 699 | P13 | S7 | E3 |
| 700 | P13 | S7 | E2 + E3 |
| 701 | P13 | S8 | E1 |
| 702 | P13 | S8 | E2 |
| 703 | P13 | S8 | E3 |
| 704 | P13 | S8 | E2 + E3 |
| 705 | P13 | S9 | E1 |
| 706 | P13 | S9 | E2 |
| 707 | P13 | S9 | E3 |
| 708 | P13 | S9 | E2 + E3 |
| 709 | P13 | S10 | E1 |
| 710 | P13 | S10 | E2 |
| 711 | P13 | S10 | E3 |
| 712 | P13 | S10 | E2 + E3 |
| 713 | P13 | S11 | E1 |
| 714 | P13 | S11 | E2 |
| 715 | P13 | S11 | E3 |
| 716 | P13 | S11 | E2 + E3 |
| 717 | P13 | S12 | E1 |
| 718 | P13 | S12 | E2 |
| 719 | P13 | S12 | E3 |
| 720 | P13 | S12 | E2 + E3 |
| 721 | P13 | S13 | E1 |
| 722 | P13 | S13 | E2 |
| 723 | P13 | S13 | E3 |
| 724 | P13 | S13 | E2 + E3 |
| 725 | P13 | S14 | E1 |
| 726 | P13 | S14 | E2 |
| 727 | P13 | S14 | E3 |
| 728 | P13 | S14 | E2 + E3 |

wherein P1 is azoxystrobin, P2 is prothioconazole, P3 is pyraclostrobin, P4 is oxyfluorfen, P5 is diefenoconazole, P6 is trifloxystrobin, P7 is propiconazole, P8 is cyproconazole, P9 is flufenacetate, P10 is epoxiconazole, P11 is fluxopyroxad, P12 is fenbuconazole and P13 is tebuconazole, S1 is benzaldehyde, S2 is 2-tolualdehyde, S3 is 3-tolualdehyde, S4 is 4-tolualdehyde, S5 is salicylaldehyde (i.e. 2-hydroxybenzaldehyde), S6 is 3-hydroxy benzaldehyde, S7 is 4-hydroxybenzaldehyde, S8 is 2-anisaldehyde (i.e. 2-methoxybenzaldehyde), S9 is 3-anisaldehyde, S10 is 4-anisaldehyde, S11 is 2-ethylbenzaldehyde, S12 is 3-ethylbenzaldehyde, S13 is 4-ethylbenzaldehyde, and S14 is 4-tertbutylbenzaldehyde, whilst E1 is any emulsifier, E2 is a block copolymer containing ethylene oxide and propylene oxide monomers and E3 is a linear alkylbenzene sulfonate.

In addition to these essential components, the emulsifiable concentrate (EC) may further comprise adjuvants conventionally used for agrochemical formulations, the choice of the adjuvants depending on the specific use form, the type of formulation or the active substance. Examples of suitable adjuvants are surface-active substances (such as solubilisers, protective colloids, wetters and tackifiers), retention agents, wetting agents, spreaders, uptake enhancers, penetration agents, spray drift controllers, crystallization inhibitors, organic and inorganic thickeners, bactericides, antifreeze agents, antifoams, optionally colorants and adhesives (for example for the treatment of seed) or conventional adjuvants for bait formulations (for example attractants, feedants, bittering substances).

The emulsifiable concentrate (EC) according to the present invention preferably comprises, more preferably consists of:
a) from 5 to 70% w/w, more preferably from 20 to 65% w/w, most preferably from 30 to 60% w/w, relative to the total weight of the emulsifiable concentrate (EC), of one or more pesticides;
b) from 1 to 30% w/w, more preferably from 5 to 20% w/w, most preferably from 10 to 15% w/w, relative to the total weight of the emulsifiable concentrate (EC), of one or more emulsifiers;
c) from 10 to 85% w/w, more preferably from 15 to 75% w/w, most preferably from 25 to 60% w/w, relative to the total weight of the emulsifiable concentrate (EC), of the solvent(s) with a structure according to formula (I); and
d) optionally from 1 to 84% w/w, more preferably from 5 to 60% w/w, most preferably from 10 to 35% w/w, relative to the total weight of the emulsifiable concentrate (EC), of one or more adjuvants,
wherein the total amount of components a), b), c), and d) do not exceed 100%.

As mentioned above, it is a finding of the present invention that many typical commercially important pesticides have improved solubility in the solvent according to the present invention, when compared with typical solvent systems used for agrochemical emulsifiable concentrates.

In addition to this finding, it has been further found that the inventive emulsifiable concentrates (EC) form highly stable emulsions when mixed with water to form emulsions, so called emulsion-in-water (EW) formulations.

The stability of an emulsion-in-water formulation may be evaluated by determining how much sedimentation or cream is formed following homogenization (i.e. following emulsification). Both cream and sedimentation represent a departure from idealized emulsion behavior, where the disperse particles either rise to the surface (creaming) or sink to the bottom (sedimentation) depending on their density. When determining the extent of creaming or sedimentation, it is not critical whether the emulsified droplets remain as such or aggregate to form a new continuous phase—both are sufficient to determine that the emulsion has broken down.

The stability of a given emulsion is dependent on a number of factors, including the nature of the two immiscible phases, the relative amounts of each phase, and the emulsifiers used to stabilize the emulsion. For the purposes of quantifying emulsion stability in the context of the present invention, a stable emulsion is viewed as an emulsion that forms less than or equal to a given amount of cream and/or sedimentation 24 hours after homogenization.

It is a finding of the present invention that the inventive emulsifiable concentrates (EC) are suitable for forming a wide range of emulsion-in-water (EW) formulations, when mixed with water and homogenized, which demonstrate unexpectedly beneficial emulsion stability.

In order to quantify this beneficial feature of the emulsifiable concentrates (EC), a model emulsion system comprising 5.0 mL of the emulsifiable concentrate (EC) and 95.0 mL of water may be used, in which case a stable emulsion is defined as an emulsion that produces less than or equal to 1.0 mL of cream or sediment, 24 hours after formation of said emulsion.

As such, it is preferred that the emulsifiable concentrate (EC) forms a stable emulsion when 5.0 mL of said emulsifiable concentrate (EC) is combined with 95.0 mL of water and homogenized, wherein a stable emulsion is defined as an emulsion having less than or equal to 1.0 mL of cream or sediment, 24 hours after formation of said emulsion.

More preferably the emulsion forms less than or equal to 0.5 mL of cream or sediment, 24 hours after formation of said emulsion.

If the emulsion does produce a measurable level of sediment or cream, it is further preferred that the emulsion may be re-homogenized, i.e. re-emulsified, to reform a stable emulsion, wherein a stable emulsion is as defined as above, wherein less than or equal to 1.0 mL of cream or sediment is formed 30 minutes after re-homogenization, more preferably wherein less than or equal to 0.5 mL of cream or sediment is formed 30 minutes after re-homogenization.

Methods for the initial homogenization and re-homogenization are well known in the art, and the precise method used in such a test is not critical.

That said, it is preferred that the homogenization is carried out by gentle inversion of the emulsion 10 times and that the re-homogenization is likewise carried out by gentle inversion of the emulsion 10 times.

As would be understood by the person skilled in the art, the threshold of how much cream or sediment would indicate that an emulsion would not be stable is dependent on the amounts of each phase present in the emulsion. As such, alternative tests, such as may be envisaged.

A model emulsion system comprising 0.5 mL of the emulsifiable concentrate (EC) and 99.5 mL of water may be used to assess stability, in which case a stable emulsion is defined as an emulsion that produces less than or equal to 0.5 mL of cream or sediment, 24 hours after formation of said emulsion. It is thus further preferred that the emulsifiable concentrate (EC) forms a stable emulsion when 0.5 mL of said emulsifiable concentrate (EC) is combined with 99.5 mL of water and homogenized, wherein a stable emulsion is defined as an emulsion having less than or equal to 0.5 mL of cream or sediment, 24 hours after formation of said emulsion.

More preferably the emulsion forms less than or equal to 0.2 mL of cream or sediment, 24 hours after formation of said emulsion.

If the emulsion does produce a measurable level of sediment or cream, it is further preferred that the emulsion may be re-homogenized, i.e. re-emulsified, to reform a stable emulsion, wherein a stable emulsion is as defined as above, wherein less than or equal to 0.5 mL of cream or sediment is formed 30 minutes after re-homogenization, preferably wherein less than or equal to 0.2 mL of cream or sediment is formed 30 minutes after re-homogenization.

### Emulsion-In-Water (EW) Formulation

As described above, the emulsifiable concentrates (EC) of the present invention are most suitable for forming highly stable emulsion-in-water (EW) formulations.

In a further aspect, the present invention is directed to an emulsion-in-water (EW) formulation, comprising an aqueous phase and a non-aqueous phase, wherein the non-aqueous phase is the emulsifiable concentrate (EC) of the first aspect.

The precise amounts of the emulsifiable concentrate (EC) and water present in the emulsion-in-water (EW) formulation are not critical; however, it is preferred that the emulsion-in-water (EW) formulation comprises, more preferably consists of, an amount in the range from 0.01 to 80.0% w/w of the emulsifiable concentrate (EC) according to the first aspect and an amount in the range of from 20.0 to 99.99% w/w of water, both amounts being expressed relative to the total weight of the emulsion-in-water (EW) formulation.

It is further preferred that that the emulsion-in-water (EW) formulation comprises, more preferably consists of, an amount in the range from 0.1 to 50.0% w/w of the emulsifiable concentrate (EC) according to the first aspect and an amount in the range of from 50.0 to 99.9% w/w of water, both amounts being expressed relative to the total weight of the emulsion-in-water (EW) formulation.

It is especially preferred that the emulsion-in-water (EW) formulation comprises, more preferably consists of, an amount in the range from 0.5 to 5.0% w/w of the emulsifiable concentrate (EC) according to the first aspect and an amount in the range of from 95.0 to 99.5% w/w of water, both amounts being expressed relative to the total weight of the emulsion-in-water (EW) formulation.

In addition to the emulsifiable concentrate (EC) according to the first aspect and water, the emulsion-in-water (EW) formulation may further contain adjuvants conventionally used for agrochemical formulations (co-called tank adjuvants), the choice of the adjuvants depending on the specific use form, the type of formulation or the active substance. Examples of suitable adjuvants are surface-active substances (such as solubilisers, protective colloids, wetters and tackifiers), retention agents, wetting agents, spreaders, uptake enhancers, penetration agents, spray drift controllers, crystallization inhibitors, organic and inorganic thickeners, bactericides, antifreeze agents, antifoams, optionally colorants and adhesives (for example for the treatment of seed) or conventional adjuvants for bait formulations (for example attractants, feedants, bittering substances).

All preferable embodiments and fallback positions relating to the emulsifiable concentrate (EC) of the first aspect are applicable mutatis mutandis to the emulsion-in-water (EW) formulation of the further aspect.

### Use

In yet a further aspect, the present invention is directed to a use of a compound having a structure according to formula (I)

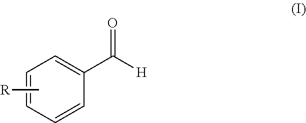

wherein R represents 0 to 5 substitutions, wherein each instance of R is selected from the group consisting of deuterium, halogen, C₁ to C₁₀ alkyl, aryl, OR¹, and NR¹₂, wherein each R¹ is selected from the group selected from hydrogen and C₁ to C₁₀ alkyl, and optionally two instances of R can be joined to form a 5-membered or 6-membered ring,
as a solvent in an agrochemical emulsifiable concentrate, preferably the emulsifiable concentrate (EC) according to the first aspect.

In yet a preferred embodiment, the present invention is directed to a use of a compound having a structure according to formula (I)

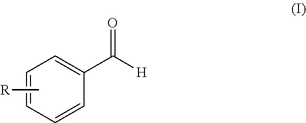

wherein R represents 0 to 5 substitutions, wherein each instance of R is selected from the group consisting of deuterium, halogen, C₁ to C₁₀ alkyl, aryl, OR¹, and NR¹₂, wherein each R¹ is selected from C₁ to C₁₀ alkyl, and optionally two instances of R can be joined to form a 5-membered or 6-membered ring,
as a solvent in an agrochemical emulsifiable concentrate, preferably the emulsifiable concentrate (EC) according to the first aspect.

All preferable embodiments and fallback positions relating to the emulsifiable concentrate (EC) of the first aspect are applicable mutatis mutandis to the use of a compound having a structure according to formula (I) of the present aspect.

Likewise, all preferable embodiments and fallback positions relating to the compound having a structure according to formula (I) given for the first aspect are applicable mutatis mutandis to the compound having a structure according to formula (I) as used in the present aspect.

In a final aspect, the present invention is directed to a use of the emulsion-in-water (EW) formulation according to the further aspect described above for treating plants, thereby maintaining plant health, without causing plant damage.

Plant damage may be evaluated relative to the treatment of the plant with an aqueous solution containing the same emulsifiers, simply without the solvent and the pesticide. Avoiding plant damage is generally achieved by using one or more pesticides known to have low phytotoxicity in combination with a solvent having low phytotoxicity.

In particular, it is preferred that the solvent has low phytotoxicity, wherein low phytotoxicity is defined as being when an emulsion containing 99.0% w/w, relative to the total weight of the emulsion, of water and 1.0% w/w, relative to the total weight of the emulsion, of a non-aqueous phase containing 90% w/w of the solvent, 7.5% w/w castor oil ethoxylate and 2.5% w/w of calcium dodecylbenzenesulfonate, each relative to the total weight of the non-aqueous phase, causes at no greater plant damage than an aqueous solution of 0.075% w/w castor oil ethoxylate and 0.025% w/w of calcium dodecylbenzenesulfonate, each relative to the total weight of the aqueous solution, when measured 14 days after application to soya plants at an application rate of 200 L per hectare.

The phytotoxicity of various commonly-used pesticides is within the common general knowledge of the person skilled in the art.

All preferable embodiments and fallback positions relating to the emulsion-in-water (EW) formulation of the further aspect described above are applicable mutatis mutandis to the use of the emulsion-in-water (EW) formulation for treating plants of the final aspect.

### EXPERIMENTAL SECTION

### Materials Used

Solvents: Benzyl acetate was purchased from Tennants Fine Chemicals. Solvesso 200 ND was purchased from Exxon Mobil. 2-Ethylhexyl Lactate, C8-C10 fatty acid methyl ester, 4-anisaldehyde and dimethyl decanamide were sourced from BASF.

CIPAC D water: Made in the lab using a standard recipe published by CIPAC “MT 18.1.4”: Standard Waters. The water has a hardness of 342 ppm, with a 4:1 mixture of Ca:Mg ions at pH 6-7.

The pesticides: azoxystrobin, prothioconazole, pyraclostrobin, oxyfluorfen, diefenoconazole, trifloxystrobin, propiconazole, cyproconazole, flufenacetate, epoxiconazole, fluxopyroxad, fenbuconazole and tebuconazole were purchased from various commercial sources

The emulsifiers: The emulsifiers used in the experiments are listed below.

| | |
|---|---|
| Emulsifier 1 | EO-PO-EO block copolymer, 40% EO, Molar Mass |
| | 4600 g/mol |
| Emulsifier 2 | EO-PO-EO block copolymer, 40% EO, Molar Mass |
| | 5900 g/mol |
| Emulsifier 3 | Alkylbenzene Sulfonate |
| Emulsifier 4 | EO-PO-EO block copolymer, 50% EO, Molar Mass |
| | 6500 g/mol |
| Emulsifier 5 | Castor Oil Ethoxylate |

### Methods

The emulsion was tested for its dispersibility by the effect known as blooming.

The emulsions were assessed according to their spontaneous emulsification when the concentrate is added to water (known in the art as “blooming”) with a visual assessment given on a scale of 1 to 5, whereby 1). Excellent, “cloud of emulsion”, does not sink to bottom of cylinder. 2). Good, “cloud of emulsion”, but sinks to bottom of cylinder 3). Okay, “poor emulsion cloud”, larger droplets 4). Poor, “no emulsion cloud”, small “particles” observed 5). Very poor, no emulsion, oil and water phases immediately separate”

The water solubility of the solvent was determined according to a method based on CIPAC MT157.1 and OECD 105 via the visual assessment of undissolved solvent in water after vigorous mixing and standing. Herein, various amounts of solvent and water were mixed with vigorous shaking in a glass-stoppered graduated cylinder or separating funnel, followed by standing for at least 30 min to enable separation. For example, if undissolved solvent was observed after thorough mixing of 0.1 g solvent in 100 mL of water, the solvent had a water-solubility equal to or below 0.1% (1 g/L). This method can be repeated with various amounts of solvent and water to enable the determination of the water-solubility of the solvent.

Under these test conditions, 4-anisaldehyde has a water solubility of 0.20% w/w.

### Example 1: Determination of Maximum Pesticide Solubility

The maximum solubility of pesticides in various solvents were determined at 21° C. Herein, small amounts of active ingredients were added to the 10 g of solvent in a 25 mL beaker under stirring with a magnetic stirrer bar. Active ingredient doses were added to the solvent until dissolution was no longer achieved, with a maximum 2 h stirring time conducted to achieve dissolution between dosing. The solubility was calculated according to the following equation:

$$Solubility [ \% ] = \frac{sum of added and dissolved active ingredient [ g ]}{\begin{matrix}mass solvent [ g ] + \\ sum of added and dissolved active ingredient [ g ]\end{matrix}} * 100$$

TABLE 1
Maximum solubility of various pesticides in various solvents

| Solvent | Azoxystrobin | Prothioconazole | Oxyfluorfen | Difenoconazole | Trifloxystrobin | Flufenacetate | Epxoiconazole |
|---|---|---|---|---|---|---|---|
| 4-Anisaldeyhde | 21 | 29 | 36 | 48 | 25 | 41 | 11 |
| Benzaldehyde | 28 | 34 | 43 | 48 | 48 | 51 | NM |
| 4-Tolualdehyde | 15 | 30 | 42 | 46 | 44 | 50 | NM |
| Sailcylaldehyde | 27 | 19 | 42 | 52 | 43 | 50 | NM |
| Benzyl Acetate | 13 | 13 | 30 | 43 | 36 | 39 | 10 |
| Solvesso 200 ND | 3 | 4 | 28 | 33 | 25 | 31 | 2 |
| 2-Ethyl hexyl lactate | 2 | 23 | 10 | 33 | NM* | 28 | 6 |
| C₈-C₁₀ fatty acid | 1 | 7 | 19 | 22 | 13 | NM | 5 |
| methyl ester | | | | | | | |
| Dimethyl decanamide | 3 | 48 | 31 | 29 | 22 | 33 | 8 |

| Solvent | Pyraclostrobin | Cyproconazole | Fluxapryoxad | Fenbuconazole | Tebuconazole | Propiconazole |
|---|---|---|---|---|---|---|
| 4-Anisaldeyhde | 53 | 23 | 14 | 17 | 15 | >50 |
| Benzaldehyde | NM | NM | NM | NM | 22 | NM |
| 4-Tolualdehyde | NM | NM | NM | NM | 20 | NM |
| Sailcylaldehyde | NM | NM | NM | NM | 25 | NM |
| Benzyl Acetate | 49 | 12 | 3 | 12 | 15 | NM |
| Solvesso 200 ND | 39 | 7 | 3 | 5 | 3 | >50 |
| 2-Ethyl hexyl lactate | 21 | NM | 2 | NM | 25 | >50 |
| C₈-C₁₀ fatty acid | 26 | NM | NM | NM | 9 | >50 |
| methyl ester | | | | | | |
| Dimethyl decanamide | 42 | 33 | 16 | 16 | 35 | >50 |

*NM = Not measured

As can be seen from Table 1, the solubilities of most pesticides were improved in 4-anisaldehyde, relative to other commonly employed solvents. In particular, azoxystrobin and prothioconazole, which were very poorly soluble in many of the comparable solvents had drastically improved solubility profiles in 4-anisaldehyde. For some individual pesticides, higher solubilities can be achieved with alternative solvents; however, the solubility profile across the broad range of pesticides was clearly far better for 4-anisaldehyde than for any of the comparative solvents.

### Example 2: Stable Pesticide Emulsions Using 4-Anisaldehyde as a Solvent

Emulsifiable concentrates were prepared in the following examples and the resulting 5% w/w emulsions in various water hardness at 21° C. after 24 hours were assessed. Emulsion stability was determined as a function of time, with the amount of either cream or sediment measured.

To measure emulsion stability, 5.0 mL of the emulsifiable concentrate was diluted in 95.0 mL CIPAC D water in a 100 mL measuring cylinder. The resulting oil-in-water emulsion stability was assessed after 1, 2, 4 and 24 hours. A highly stable emulsion does not form cream, or have less than 1.0 mL cream after 24 hours, and can be readily re-emulsified after 24 h of standing without the formation of cream, with such re-emulsified emulsions assessed 30 minutes after re-emulsification. Both the initial emulsification and the re-emulsification were achieved by gently inverting the emulsion 10 times.

TABLE 2.1.1
Azoxystrobin formulation emulsion testing

| | | IE1 | CE1 | CE2 | CE3 |
|---|---|---|---|---|---|
| Component | | | | | |
| Azoxystrobin | | 15 | 15 | 15 | 15 |
| 4-Anisaldehyde | | 73 | | | |
| Benzyl Acetate | | | 73 | | |
| Solvesso 200 ND | | | | 73 | |
| Dimethyl decamide | | | | | 73 |
| Emulsifier 1 | | 8 | 8 | 8 | 8 |
| Emulsifier 3 | | 4 | 4 | 4 | 4 |
| EC Appearance | | Clear, | Unsta- | Unsta- | Unsta- |
| | | Stable | ble, | ble, | ble, |
| | | | sep- | sep- | sep- |
| | | | aration | aration | aration |
| Emulsion Properties | | | | | |
| Blooming | | 2 | NM** | NM | NM |
| Emulsion 1 h | mL | <0.1 | NM | NM | NM |
| Emulsion 2 h | cream | <0.1 | NM | NM | NM |
| Emulsion 4 h | or | <0.1 | NM | NM | NM |
| Emulsion 24 h | sediment | 0.5 | NM | NM | NM |
| Re-emulsification | | <0.1 | NM | NM | NM |
| 30 min | | | | | |

* Emulsion tests conducted in CIPAC D water (342 ppm hardness, 4:1 Ca:Mg, pH 6-7) at 21° C.
**NM = not measured, due to instability of EC

TABLE 2.1.2
Azoxystrobin formulation emulsion low temperature re-circulation test
A low-temperature emulsion re-circulation test was conducted to assess the stability of the emulsion under field application conditions. Herein, a 5 L temperature-controlled vessel isothermally maintained at 4° C. containing 3 L of pesticide emulsion at 0.5% w/w emulsifiable concentrate was prepared. The emulsion contains 3 L CIPAC D water and 15 g of emulsifiable concentrate, resulting in an emulsion concentration of 0.5% w/w. The resulting emulsion was pumped through a metal filter with a 140 μm pore size attached to the temperature-controlled vessel at a flow rate of 1 L/min for 6 h at 4° C., wherein the pressure was continually monitored. A perfectly stable emulsion maintains a pressure <1.0 bar throughout the 6 h re-circulation period, and the filter after 6 h re-circulation was removed and dried, with a total collected solid material <100 mg measured.

| | IE1 |
|---|---|
| | (of Table 2.1.1) |
| Vessel pressure after 6 h re-circulation [bar] | 0.6 |
| Weight of collected dried filter material after 6 h [mg] | 38.4 |

No evaluation was possible for any of the comparative examples, since the unstable emulsions would have blocked the equipment.

TABLE 2.2
Further pesticide EC formulation testing under standard conditions

| Component | | IE2 | IE3 | IE4 | IE5 | IE6 | IE7 | IE8 |
|---|---|---|---|---|---|---|---|---|
| Oxyfluorfen | | 25 | | | | | | |
| Trifloxystrobin | | | 20 | | | | | |
| Difenoconazole | | | | 30 | | | | |
| Flufenacetaet | | | | | 30 | | | |
| Pyraclostrobin | | | | | | 40 | | |
| Fluxapyroxad | | | | | | | 10 | |
| Fenbuconazole | | | | | | | | 14 |
| 4-Anisaldehyde | | 63 | 68 | 58 | 58 | 48 | 78 | 74 |
| Emulsifier 1 | | 8 | 8 | 7 | 8 | | 8 | 8 |
| Emulsifier 2 | | | | | | 8 | | |
| Emulsifier 3 | | 4 | 4 | 5 | 4 | 4 | 4 | 4 |
| EC Appearance | | Clear, | Clear, | Clear, | Clear, | Clear, | Clear, | Clear, |
| | | Stable | stable | Stable | Stable | Stable | Stable | Stable |
| Emulsion Properties | | | | | | | | |
| Blooming | | 2 | 2 | 2 | 2 | 2 | 2 | 2 |
| Emulsion 1 h | mL | <0.1 | <0.1 | 0.2 | <0.1 | <0.1 | <0.1 | <0.1 |
| Emulsion 2 h | cream or | <0.1 | <0.1 | 0.3 | 0.3 | <0.1 | <0.1 | <0.1 |
| Emulsion 4 h | sediment | 0.5 | 0.5 | 0.5 | 0.5 | 0.2 | <0.1 | <0.1 |
| Emulsion 24 h | | 1.0 | 1.0 | 1.0 | 0.5 | 0.5 | 0.5 | 1.0 |
| Re-emulsification 30 min | | <0.1 | <0.1 | 0.2 | <0.1 | <0.1 | <0.1 | <0.1 |

* Emulsion tests conducted in CIPAC D water (342 ppm hardness, 4:1 Ca:Mg, pH 6-7) at 21° C.
** NM = not measured, due to instability of EC

TABLE 2.3
Testing of EC formulations with various pesticide active ingredient mixtures

| Component | | IE9 | CE4 | IE10 | CE5 | IE13 | CE6 |
|---|---|---|---|---|---|---|---|
| Azoxystrobin | | 15 | 15 | 10 | 10 | | |
| Cyproconazole | | 6 | 6 | | | 13 | 13 |
| Prothioconazole | | | | 13 | 13 | | |
| Fenbuconazole | | | | | | 13 | 13 |
| 4-Anisaldehyde | | 67 | | 65 | | 62 | |
| Benzyl Acetate | | | 67 | | 65 | | 62 |
| Emulsifier 1 | | 8 | 8 | | | 8 | 8 |
| Emulsifier 2 | | | | 8 | 8 | | |
| Emulsifier 3 | | 4 | 4 | 4 | 4 | 4 | 4 |
| EC Appearance | | Clear, | Unstable, | Clear, | Unstable, | Clear, | Unstable, |
| | | Stable | separation | Stable | separation | Stable | separation |
| Emulsion Properties | | | | | | | |
| Blooming | | 2 | NM | 2 | NM | 2 | NM |
| Emulsion 1 h | mL | <0.1 | NM | <0.1 | NM | <0.1 | NM |
| Emulsion 2 h | cream or | <0.1 | NM | <0.1 | NM | <0.1 | NM |
| Emulsion 4 h | sediment | 0.3 | NM | <0.1 | NM | 0.5 | NM |
| Emulsion 24 h | | 1.0 | NM | 1.0 | NM | 1.0 | NM |
| Re-emulsification 30 min | | <0.1 | NM | <0.1 | NM | <0.1 | NM |

* Emulsion tests conducted in CIPAC D water (342 ppm hardness, 4:1 Ca:Mg, pH 6-7) at 21° C.
** NM = not measured, due to instability of EC

As can be seen from IE1 to IE13 in Tables 2.1.1 to 2.3, a wide range of agrochemically active compounds (i.e. pesticides) can be provided as emulsifiable concentrates for application onto crops. These pesticides may either be added individually or as part of so-called ‘combination products’. Many of the emulsifiable concentrates exemplified in the above tables, especially those containing azoxystrobin and prothioconazole, are notoriously insoluble in typical EC solvents, such as benzyl acetate, as demonstrated by the comparative examples CE1 to CE6.

### Example 3: Stable Pesticide Emulsions Using Other Aldehyde-Based Solvents

Emulsifiable concentrates were prepared in the following examples and the resulting 5% w/w emulsions in various water hardness at 21° C. after 24 hours were assessed. Emulsion stability was determined as a function of time, with the amount of either cream or sediment measured.

To measure emulsion stability, 5.0 mL of the emulsifiable concentrate was diluted in 95.0 mL CIPAC D water in a 100 mL measuring cylinder. The resulting oil-in-water emulsion stability was assessed after 1, 2, 4 and 24 hours. A highly stable emulsion does not form cream, or have less than 1.0 mL cream after 24 hours, and can be readily re-emulsified after 24 h of standing without the formation of cream, with such re-emulsified emulsions assessed 30 minutes after re-emulsification. Both the initial emulsification and the re-emulsification were achieved by gently inverting the emulsion 10 times.

TABLE 3.1
Testing of EC formulations with salicylaldehyde or benzaldehyde as a solvent

| Component | | IE14 | CE7 | IE15 | CE8 | IE16 | CE9 |
|---|---|---|---|---|---|---|---|
| Oxyfluorfen | | 30 | 30 | | | 30 | 30 |
| Azoxystrobin | | | | 20 | 20 | | |
| Trifloxystrobin | | | | | | | |
| Flufenacetate | | | | | | | |
| Salicylaldehyde | | 58 | | 68 | | | |
| Benzaldehyde | | | | | | 58 | |
| Benzyl Acetate | | | 58 | | 68 | | 58 |
| Emulsifier 1 | | 8 | 8 | | | | |
| Emulsifier 3 | | 4 | 4 | 1 | 4 | 4 | 4 |
| Emulsifier 4 | | | | 8 | 8 | | |
| Emulsifier 5 | | | | | | 8 | 8 |
| EC Appearance | | Clear, | Unstable, | Clear, | Unstable, | Clear, | Unstable, |
| | | Stable | separation | stable | separation | Stable | separation |
| Emulsion | | | | | | | |
| Properties | | | | | | | |
| Blooming | | 2 | NM | 2 | NM | 2 | NM |
| Emulsion 1 h | mL | <0.1 | NM | <0.1 | NM | <0.1 | NM |
| Emulsion 2 h | cream or | <0.1 | NM | <0.1 | NM | <0.1 | NM |
| Emulsion 4 h | sediment | <0.1 | NM | <0.1 | NM | <0.1 | NM |
| Emulsion 24 h | | 0.2 | NM | 0.2 | NM | 0.5 | NM |
| Re-emulsification | | <0.1 | NM | <0.1 | NM | <0.1 | NM |
| 30 min | | | | | | | |
| Component | | IE17 | CE10 | IE18 | CE11 | IE19 | CE12 |
| Oxyfluorfen | | | | | | | |
| Azoxystrobin | | 20 | 20 | | | | |
| Trifloxystrobin | | | | 40 | 40 | | |
| Flufenacetate | | | | | | 40 | 40 |
| Salicylaldehyde | | | | | | | |
| Benzaldehyde | | 68 | | 48 | | 48 | |
| Benzyl Acetate | | | 68 | | 48 | | 48 |
| Emulsifier 1 | | 9 | 9 | | | 8 | 8 |
| Emulsifier 3 | | 3 | 3 | 4 | 1 | 4 | 4 |
| Emulsifier 4 | | | | | | | |
| Emulsifier 5 | | | | 8 | 8 | | |
| EC Appearance | | Clear, | Unstable, | Clear, | Unstable, | Clear, | Unstable, |
| | | stable | separation | Stable | separation | stable | separation |
| Emulsion | | | | | | | |
| Properties | | | | | | | |
| Blooming | | 2 | NM | 2 | NM | 2 | NM |
| Emulsion 1 h | mL | <0.1 | NM | <0.1 | NM | <0.1 | NM |
| Emulsion 2 h | cream or | <0.1 | NM | <0.1 | NM | <0.1 | NM |
| Emulsion 4 h | sediment | <0.1 | NM | <0.1 | NM | <0.1 | NM |
| Emulsion 24 h | | 1.0 | NM | 0.5 | NM | 0.5 | NM |
| Re-emulsification | | <0.1 | NM | <0.1 | NM | <0.1 | NM |
| 30 min | | | | | | | |

* Emulsion tests conducted in CIPAC D water (342 ppm hardness, 4:1 Ca:Mg, pH 6-7) at 21° C.
** NM = not measured, due to instability of EC

TABLE 3.2
Testing of EC formulations with 4-tolualdehyde as the solvent

| Component | | IE20 | CE13 | IE21 | CE14 | IE22 | CE15 | IE23 | CE16 |
|---|---|---|---|---|---|---|---|---|---|
| Azoxystrobin | | 12 | 12 | | | | | | |
| Oxyfluorfen | | | | 30 | 30 | | | | |
| Difenoconazole | | | | | | 35 | 35 | | |
| Flufenacetate | | | | | | | | 40 | 40 |
| 4-Tolualdehyde | | 76 | | 58 | | 53 | | 48 | |
| Benzyl Acetate | | | 76 | | 58 | | 53 | | 48 |
| Emulsifier 1 | | 8 | 8 | | | | | | |
| Emulsifier 3 | | 4 | 4 | 4 | 4 | 4 | 4 | 4 | 4 |
| Emulsifier 5 | | | | 8 | 8 | 8 | 8 | 8 | 8 |
| EC Appearance | | Clear, | Unstable, | Clear, | Unstable, | Clear, | Unstable, | Clear, | Unstable, |
| | | Stable | separation | Stable | separation | Stable | solidification | Stable | separation |
| Emulsion Properties | | | | | | | | | |
| Blooming | | 2 | NM | 2 | NM | 2 | NM | 2 | NM |
| Emulsion 1 h | mL | <0.1 | NM | <0.1 | NM | <0.1 | NM | <0.1 | NM |
| Emulsion 2 h | cream or | <0.1 | NM | <0.1 | NM | <0.1 | NM | <0.1 | NM |
| Emulsion 4 h | sediment | <0.1 | NM | <0.1 | NM | 0.3 | NM | <0.1 | NM |
| Emulsion 24 h | | 1.0 | NM | <0.1 | NM | 0.5 | NM | <0.1 | NM |
| Re-emulsification 30 min | | <0.1 | NM | <0.1 | NM | <0.1 | NM | <0.1 | NM |

* Emulsion tests conducted in CIPAC D water (342 ppm hardness, 4:1 Ca:Mg, pH 6-7) at 21° C.
** NM = not measured, due to instability of EC

As can be seen from IE14 to IE23 in Tables 3.1 and 3.2, a broad range of benzaldehyde-based solvents may be used as solvents for emulsifiable concentrates containing various agrochemically active compounds (i.e. pesticides). Many of the emulsifiable concentrates exemplified in the above tables, especially those containing azoxystrobin, are notoriously insoluble in typical EC solvents, such as benzyl acetate, as demonstrated by the comparative examples CE7 to CE16.

### Example 4: Phytotoxicity Determination on Soya

Soya plants grown under standard greenhouse conditions in the growth stage 13 were treated with aqueous emulsions in a spray cabin. The resulting plant spray dosage represented an application rate of 200 L/ha of 1% w/w emulsion, corresponding to the application of 2 L/ha of the emulsifiable concentrate. The emulsifiable concentrate contains 90% w/w solvent and 10% w/w emulsifier (emulsifier mix 75% w/w castor oil ethoxylate and 25% w/w calcium dodecylbenzenesulfate). The experimental period lasted 14 days, during which time the Soya plants were given optimum watering, nutrients, and light.

Solvent phytotoxicity was evaluated via visual examination on a scale of 0% to 100%, relative to plants treated with an aqueous solution of 0.075% w/w castor oil ethoxylate and 0.025% w/w of calcium dodecylbenzenesulfonate (see FIG. 1). Hereby, 0% represents no plant damage, with no difference between treated and untreated plants. An assessment of 1 to 10% phytotoxicity is the limit of acceptable plant damage by farmers. A phytotoxicity level from 11 to 30% represents moderate damage, between 31% and 60% high damage, above 61% very high damage and a rating of 100% representing complete plant destruction.

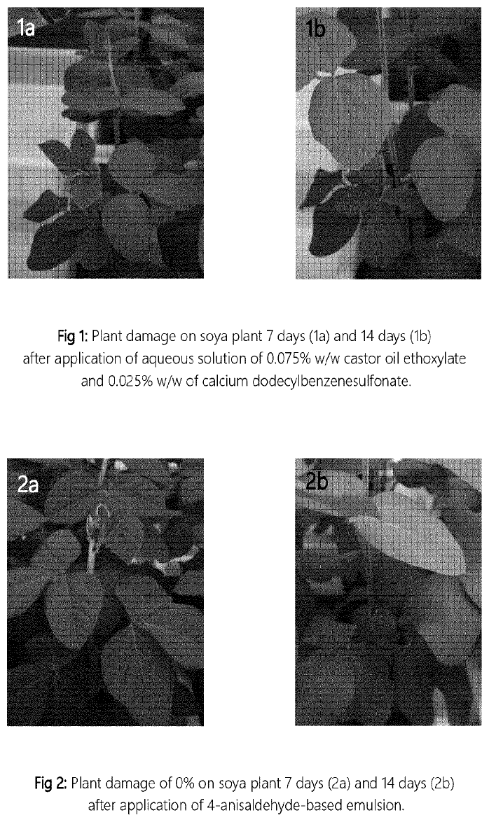

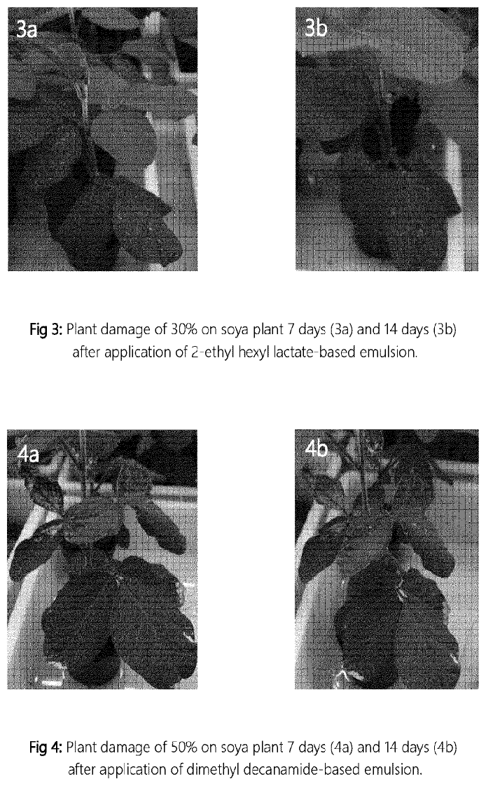

As a plant phytotoxicity of 0% was observed for the inventive anisaldehyde solvent (see FIG. 2), in can be stated that 4-anisaldehyde is completely selective and non-phytotoxic. On the other hand, the application of the non-inventive solvents 2-ethyl hexyl lactate and dimethyl decanamide results in 30% and 50% phytotoxicity after 14 days respectively (see FIGS. 3 and 4).

The inventive solvents have no or almost no phytotoxic effects, and therefore can be used in agricultural formulations for reducing plant phytotoxicity in such compositions.

1. An emulsifiable concentrate (EC) comprising one or more pesticides, one or more emulsifiers and one or more solvents, wherein at least one of the one or more solvents has a structure according to formula (I): 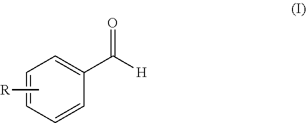
wherein R represents 0 to 5 substitutions, wherein each instance of R is selected from the group consisting of deuterium, halogen, C₁ to C₁₀ alkyl, aryl, OR¹, and NR¹₂, wherein each R¹ is selected from the group consisting of hydrogen and C₁ to C₁₀ alkyl, and optionally two instances of R can be joined to form a 5-membered or 6-membered ring.

2. The emulsifiable concentrate (EC) according to claim 1, wherein each instance of R is OR¹.

3. The emulsifiable concentrate (EC) according to claim 2, wherein the solvent is selected from the group consisting of 2-anisaldehyde, 3-anisaldehyde and 4-anisaldehyde.

4. The emulsifiable concentrate (EC) according to claim 1, wherein the solvent has a water solubility of less than 1.00% w/w.

5. The emulsifiable concentrate (EC) according to claim 1, wherein at least one of the one or more pesticides is selected from the group consisting of azoxystrobin, prothioconazole, pyraclostrobin, oxyfluorfen, diefenoconazole, trifloxystrobin, propiconazole, cyproconazole, flufenacetate, epoxiconazole, fluxopyroxad, fenbuconazole and tebuconazole.

6. The emulsifiable concentrate (EC) according to claim 1, wherein the total pesticide content is in the range from 5 to 70% w/w, relative to the total weight of the emulsifiable concentrate (EC).

7. The emulsifiable concentrate (EC) according to claim 1, wherein at least one of the one or more pesticides is azoxystrobin or prothioconazole and the combined content of azoxystrobin and prothioconazole in the emulsifiable concentrate (EC) is in the range from 10 to 50% w/w, relative to the total weight of the emulsifiable concentrate (EC).

8. The emulsifiable concentrate (EC) according to claim 1, comprising two or more pesticides.

9. The emulsifiable concentrate (EC) according to claim 1, containing one or more non-ionic emulsifier(s) and one or more anionic emulsifier(s).

10. The emulsifiable concentrate (EC) according to claim 1, wherein at least one of the one or more emulsifiers is a copolymer containing ethylene oxide and propylene oxide monomers.

11. The emulsifiable concentrate (EC) according to claim 1, wherein at least one of the one or more emulsifiers is an alkyl benzene sulfonate.

12. The emulsifiable concentrate (EC) according to claim 1, wherein the emulsifiable concentrate (EC) forms a stable emulsion when 5.0 mL of said emulsifiable concentrate (EC) is combined with 95.0 mL of water and homogenized, wherein a stable emulsion is defined as an emulsion having less than or equal to 1.0 mL of cream or sediment, 24 hours after formation of said emulsion.

13. An emulsion-in-water (EW) formulation, comprising an aqueous phase and a non-aqueous phase, wherein the non-aqueous phase is the emulsifiable concentrate (EC) according to claim 1.

14. A method of using a compound having a structure according to formula (I) 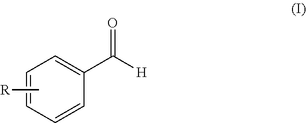
wherein R represents 0 to 5 substitutions, wherein each instance of R is selected from the group consisting of deuterium, halogen, C₁ to C₁₀ alkyl, aryl, OR¹, and NR¹₂, wherein each R¹ is selected from the group consisting of hydrogen and C₁ to C₁₀ alkyl, and optionally two instances of R can be joined to form a 5-membered or 6-membered ring, the method comprising using the compound as a solvent in an agrochemical emulsifiable concentrate.

15. A method of using the emulsion-in-water (EW) formulation according to claim 13, the method comprising using the EW formulation for treating plants, thereby maintaining plant health, without causing plant damage.

16. The emulsifiable concentrate (EC) according to claim 2, wherein the solvent is selected from the group consisting of 4-anisaldehyde.

17. The emulsifiable concentrate (EC) according to claim 1, wherein the solvent has a water solubility of less than 0.50% w/w.

18. The emulsifiable concentrate (EC) according to claim 1, wherein the total pesticide content is in the range from 20 to 65% w/w, relative to the total weight of the emulsifiable concentrate (EC).

19. The emulsifiable concentrate (EC) according claim 1, wherein at least one of the one or more pesticides is azoxystrobin or prothioconazole and the combined content of azoxystrobin and prothioconazole in the emulsifiable concentrate (EC) is in the range from 13 to 40% w/w, relative to the total weight of the emulsifiable concentrate (EC).

20. The method of claim 14, wherein the emulsifiable concentrate (EC) comprises-one or more pesticides and one or more emulsifiers.
